(19) United States
(12) Patent Application Publication
(10) Pub. No.: US 2014/0294080 A1
(43) Pub. Date: Oct. 2, 2014

(54) IMAGE PROCESSING DEVICE, IMAGE PROCESSING METHOD, AND COMPUTER PROGRAM

(71) Applicant: Sony Corporation, Tokyo (JP)

(72) Inventor: Kuniaki Kurihara, Tokyo (JP)

(73) Assignee: Sony Corporation, Tokyo (JP)

(21) Appl. No.: 14/215,155

(22) Filed: Mar. 17, 2014

(30) Foreign Application Priority Data
Mar. 26, 2013 (JP) 2013-064014

(51) Int. Cl. H04N 19/597; H04N 19/51

(52) U.S. Cl. CPC H04N 19/00769; H04N 19/00696
USPC 375/240.16

(57) ABSTRACT

There is provided an image processing device including a combining unit configured to combine a plurality of encoded streams before the streams are decoded and to detect a loss of information in the plurality of encoded streams, and an alternative information providing unit configured to provide the combining unit with alternative information that serves as an alternative to the loss when the combining unit detects the loss, wherein the combining unit performs composite by replacing a portion including the loss in information in the plurality of encoded streams by the alternative information.

### CROSS REFERENCE TO RELATED APPLICATIONS

This application claims the benefit of Japanese Priority Patent Application JP 2013-064014 filed Mar. 26, 2013, the entire contents of which are incorporated herein by reference.

### BACKGROUND

The present disclosure relates to an image processing device, an image processing method, and a computer program.

Since digitization of content and infrastructure that enables transmission of images have been developed, images are more and more commonly distributed through the Internet. In recent years, other than personal computers, more and more television receivers connectable to a network have been made as receiver devices. Thus, it is becoming possible to watch distributed moving image content on television receivers.

Further, cloud service has been developed in recent years, so that a variety of channels including private content have been provided for viewers through a network. Accordingly, there are more and more needs for a multi-image reproducing system that enables simultaneous viewing of a plurality of moving image content items and easy retrieval of a moving image content item to watch.

There is a system that performs multi-screen composite using encoded stream information to achieve simultaneous viewing of a plurality of moving image content items. A plurality of encoded stream information items held by being compressed by a server are converted into one encoded stream information item without a complicated decoding process performed by a client. The multi-screen composite using the encoded stream information can reduce a load on a process performed by the server, a network band to be used, and a load on a process performed by the client.

### SUMMARY

With this technique, however, a client cannot generate a combined picture when the encoded stream information item to be input to a process of the multi-screen composite includes, if any, a slight loss. Further, when the arrival of the information is delayed, it is necessary to await the arrival of every stream required for the multi-screen composite; accordingly, it is difficult to handle real-time content items in a case of video chat, for example.

Accordingly, one or more of embodiments of the present disclosure provides an image processing device, an image processing method, and a computer program that are novel and improved and can enable a client to execute a process of multi-screen composite even when a loss or a delay is generated at a time of transmitting a plurality of encoded stream information items that are held by being compressed by a server.

According to an embodiment of the present disclosure, there is provided an image processing device including a combining unit configured to combine a plurality of encoded streams before the streams are decoded and to detect a loss of information in the plurality of encoded streams, and an alternative information providing unit configured to provide the combining unit with alternative information that serves as an alternative to the loss when the combining unit detects the loss. The combining unit performs composite by replacing a portion including the loss in information in the plurality of encoded streams by the alternative information.

According to another embodiment of the present disclosure, there is provided an information processing method including combining a plurality of encoded streams before the streams are decoded, detecting a loss of information in the plurality of encoded streams, and providing alternative information serving as an alternative to the loss when the loss is detected in the detecting step. In the combining step, composite is performed by replacing a portion including the loss in information in the plurality of encoded streams by the alternative information.

According to another embodiment of the present disclosure, there is provided a computer program causing a computer to execute combining a plurality of encoded streams before the streams are decoded, detecting a loss of information in the plurality of encoded streams, and providing alternative information serving as an alternative to the loss when the loss is detected in the detecting step. In the combining step, composite is performed by replacing a portion including the loss in information in the plurality of encoded streams by the alternative information.

As described above, according to one or more of embodiments of the present disclosure, it is possible to provide an image processing device, an image processing method, and a computer program that are novel and improved and can enable a client to execute a process of multi-screen composite even when a loss or a delay is generated at a time of transmitting a plurality of encoded stream information items that are held by being compressed by a server.

### BRIEF DESCRIPTION OF THE DRAWINGS

FIG. 1 shows an overall configuration example of an image processing system 1 according to an embodiment of the present disclosure;

FIG. 2 shows a function configuration example of moving image content servers 2 and 3 according to an embodiment of the present disclosure;

FIG. 3 shows a function configuration example of moving image content servers 2 and 3 according to an embodiment of the present disclosure;

FIG. 4 shows a function configuration example of a client terminal 100 according to an embodiment of the present disclosure;

FIG. 5 shows a process of combining a plurality of encoded streams in a stream combining unit 105;

FIG. 6 shows a process of combining a plurality of encoded streams in a stream combining unit 105;

FIG. 7 shows a state of a plurality of encoded streams that have been combined in a stream combining unit 105;

FIG. 8 shows a process of combining a plurality of encoded streams in a stream combining unit 105;

FIG. 9 shows a process of combining a plurality of encoded streams in a stream combining unit 105;

FIG. 10 shows a function configuration example of a client terminal 100 according to an embodiment of the present disclosure;

FIG. 11 shows a function configuration example of moving image content servers 2 and 3 according to an embodiment of the present disclosure;

FIG. 12 shows a function configuration example of an alternative picture generating unit 108 included in a client terminal 100 according to an embodiment of the present disclosure;

FIG. 13 shows a configuration example of an IDR picture memory generating unit 112 included in an alternative picture generating unit 108;

FIG. 14 is a flow chart showing an operation example of a client terminal 100 according to an embodiment of the present disclosure;

FIG. 15A is a flow chart showing an operation example of a client terminal 100 according to an embodiment of the present disclosure;

FIG. 15B is a flow chart showing an operation example of a client terminal 100 according to an embodiment of the present disclosure;

FIG. 15C is a flow chart showing an operation example of a client terminal 100 according to an embodiment of the present disclosure;

FIG. 16 is a flow chart showing an operation example of a client terminal 100 according to an embodiment of the present disclosure;

FIG. 17A is a flow chart showing an operation example of a client terminal 100 according to an embodiment of the present disclosure;

FIG. 17B is a flow chart showing an operation example of a client terminal 100 according to an embodiment of the present disclosure;

FIG. 18 shows a process of combining a plurality of encoded streams performed by a client terminal 100 according to an embodiment of the present disclosure;

FIG. 19 shows a process of combining a plurality of encoded streams performed by a client terminal 100 according to an embodiment of the present disclosure;

FIG. 20 shows an example of encoded streams that have arrived at a client terminal 100 according to an embodiment of the present disclosure;

FIG. 21 shows an example of encoded streams that have arrived at a client terminal 100 according to an embodiment of the present disclosure;

FIG. 22 shows an example of encoded streams that have arrived at a client terminal 100 according to an embodiment of the present disclosure;

FIG. 23 shows an example of encoded streams that have arrived at a client terminal 100 according to an embodiment of the present disclosure;

FIG. 24 shows an example of encoded streams that have arrived at a client terminal 100 according to an embodiment of the present disclosure;

FIG. 25 shows an example of encoded streams that have arrived at a client terminal 100 according to an embodiment of the present disclosure;

FIG. 26 shows an example of encoded streams that have arrived at a client terminal 100 according to an embodiment of the present disclosure; and

FIG. 27 shows an example of encoded streams that have arrived at a client terminal 100 according to an embodiment of the present disclosure.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Note that the description will be made in the following order.

<1. Embodiment of Present Disclosure>

[Overall Configuration Example]

[Function Configuration Example of Moving Image Content Server]

[Function Configuration Example of Client Terminal]

[Operation Example of Client Terminal]

<2. Conclusion>

### 1. EMBODIMENT OF PRESENT DISCLOSURE

### Overall Configuration Example

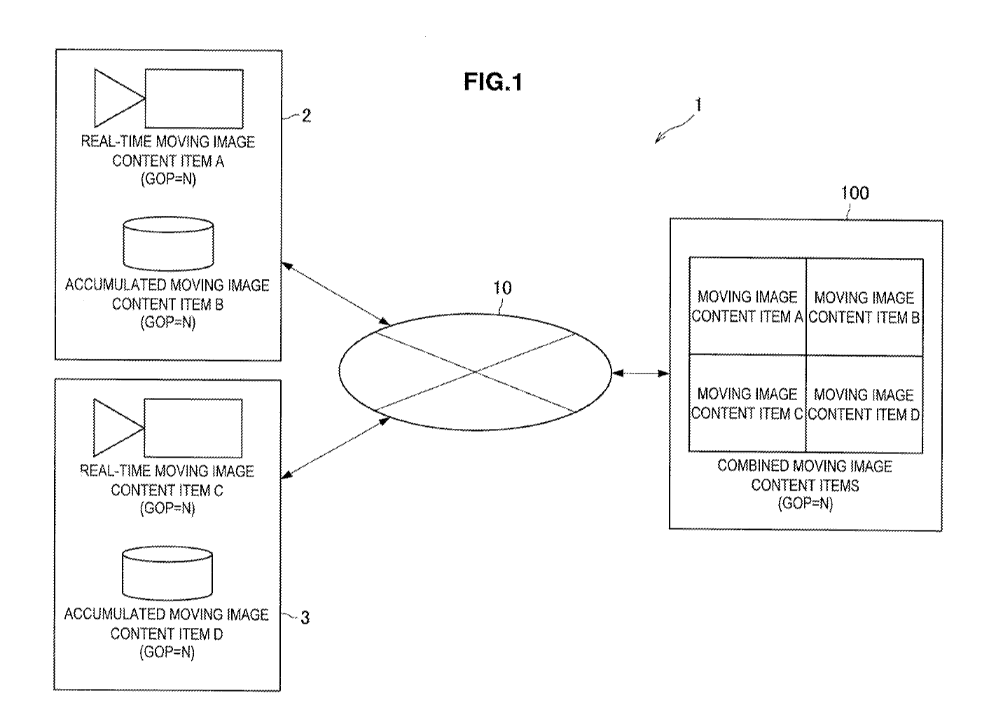

First of all, an overall configuration example of a system according to an embodiment of the present disclosure will be described with reference to drawings. FIG. 1 shows an overall configuration example of an image processing system 1 according to an embodiment of the present disclosure. The overall configuration example of the image processing system 1 according to an embodiment of the present disclosure will be described below with reference to FIG. 1.

The image processing system 1 shown in FIG. 1 has a configuration in which a client terminal 100 receives encoded stream information from a plurality of moving image content servers 2 and 3 through a network 10 such as the Internet, and the client terminal 100 included in the image processing system 1 shown in FIG. 1 decodes the received encoded stream information from the moving image content servers 2 and 3 and combines a plurality of moving image content items to reproduce the moving image content items simultaneously.

The moving image content servers 2 and 3 each hold moving image content that is converted into encoded streams, convert moving image content into encoded streams, and transmit the encoded streams to the client terminal 100 in accordance with a request from the client terminal 100. In this embodiment, the moving image content server 2 holds a real-time moving image content item A that is a moving image content item shot in real time and an accumulated moving image content item B that is a moving image content item that has been shot in advance. Further, the moving image content server 3 holds a real-time moving image content item C that is a moving image content item shot in real time and an accumulated moving image content item D that is a moving image content item that has been shot in advance. It is needless to say that kinds and the number of moving image content items held by the moving image content servers are not limited to the above examples.

The encoded streams in this embodiment are encoded by an H.264/advanced video coding (AVC) scheme, for example. It is needless to say that an encoding scheme is not limited to this example.

The client terminal 100 receives a plurality of the encoded streams that are transmitted from the moving image content servers 2 and 3 through the network 10 such as the Internet, combines the plurality of the encoded streams, and decodes the combined encoded streams. By decoding the plurality of encoded streams after composite, the client terminal 100 can reproduce a plurality of moving image content items simultaneously. Note that the simultaneous reproduction of a plurality of moving image content items may be executed by the client terminal 100 or may be executed by another device having a display screen and connected to the client terminal 100 with or without wires.

Each of the moving image content items that are held by the moving image content servers 2 and 3 is assumed to have N groups of pictures (GOP). The same GOP in the moving image content items enables the client terminal 100 to combine the plurality of encoded streams and to decode the combined encoded streams.

The overall configuration example of the image processing system 1 according to an embodiment of the present disclosure has been described above with reference to FIG. 1. Next, function configuration examples of the moving image content servers 2 and 3 according to an embodiment of the present disclosure will be described.

### Function Configuration Example of Moving Image Content Server

As described above, the moving image content servers 2 and 3 according to an embodiment of the present disclosure can each hold any of real-time moving image content and accumulated moving image content. Accordingly, function configuration examples of the moving image content servers 2 and 3 according to an embodiment of the present disclosure in a case where the real-time moving image content is distributed and in a case where the accumulated moving image content is distributed will be described.

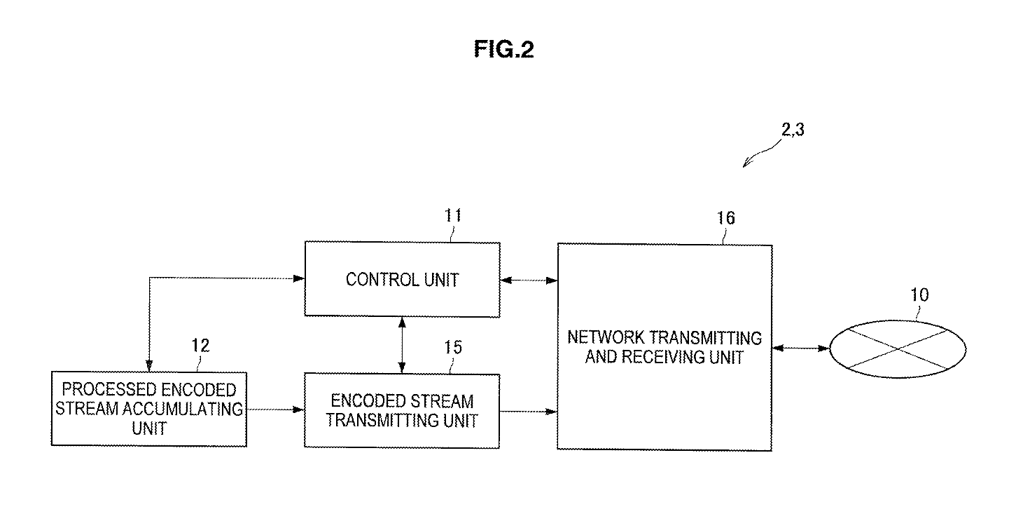

FIG. 2 shows a function configuration example of the moving image content servers 2 and 3 according to an embodiment of the present disclosure. FIG. 2 shows the function configuration example of the moving image content servers 2 and 3 when the real-time moving image content is distributed.

As shown in FIG. 2, the moving image content servers 2 and 3 according to an embodiment of the present disclosure each include a control unit 11, a processed encoded stream accumulating unit 12, an encoded stream transmitting unit 15, and a network transmitting and receiving unit 16.

The control unit 11 controls operation of each unit in the moving image content servers 2 and 3. The processed encoded stream accumulating unit 12 recodes moving image content in advance and accumulates recoded encoded streams. The recoded encoded streams of moving image content, which are accumulated in the processed encoded stream accumulating unit 12, are transmitted to the encoded stream transmitting unit 15 under control of the control unit 11.

Encoded streams using the H.264/AVC scheme has a dependence relationship with context-based adaptive binary arithmetic coding (CABAC), intra macro block (MB) prediction, motion vector prediction, and the like, in the same slice. Coding is performed in every horizontal line from the top, and from the left in each horizontal line.

The processed encoded stream accumulating unit 12 accumulates macro blocks of the encoded streams of moving image content, the macro blocks being arranged in the horizontal direction and recoded as the same slice. By recoding the macro blocks arranged in the horizontal direction as the same slice, the dependence relationship between macro blocks having different positions in the vertical direction disappears in each moving image content item. Therefore, by combining a plurality of encoded streams of moving image content items in the client terminal 100, even when the encoding order of the macro blocks is different, the multi-picture reproduction image that is subjected to decoding becomes the same as the image of the original moving image content.

The encoded stream transmitting unit 15 causes the network transmitting and receiving unit 16 to transmit the encoded streams of moving image content accumulated in the processed encoded stream accumulating unit 12 using a protocol such as a transmission control protocol (TCP) or a real-time transport protocol (RTP), under control of the control unit 11.

The network transmitting and receiving unit 16 receives data from the network 10 and transmits data to the network 10. In this embodiment, the network transmitting and receiving unit 16 receives the encoded streams of moving image content transmitted from the encoded stream transmitting unit 15 and transmits the encoded streams to the network 10 under control of the control unit 11.

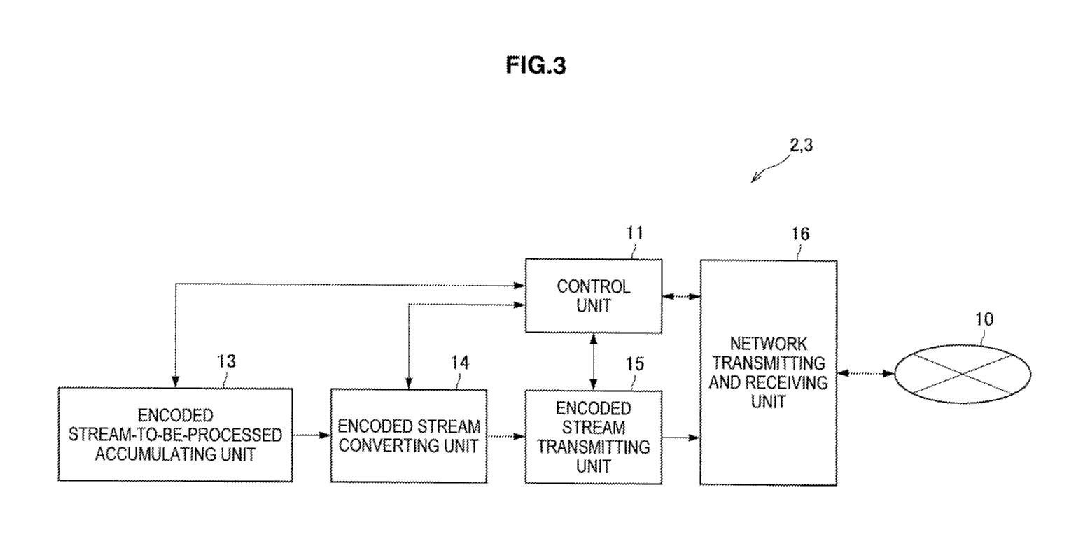

FIG. 3 shows a function configuration example of the moving image content servers 2 and 3 according to an embodiment of the present disclosure. FIG. 3 shows the function configuration example of the moving image content servers 2 and 3 when the real-time moving image content that is shot in real time is distributed, for example.

As shown in FIG. 3, the moving image content servers 2 and 3 according to an embodiment of the present disclosure each include the control unit 11, an encoded stream-to-be-processed accumulating unit 13, an encoded stream converting unit 14, the encoded stream transmitting unit 15, and the network transmitting and receiving unit 16.

The control unit 11 controls operation of each element in the moving image content servers 2 and 3. The encoded stream-to-be-processed accumulating unit 13 accumulates encoded streams of real-time moving image content that is not subjected to the above-described recoding. The encoded streams of real-time moving image content accumulated in the encoded stream-to-be-processed accumulating unit 13 are transmitted to the encoded stream converting unit 14 under control of the control unit 11.

The encoded stream converting unit 14 performs the above-described recoding on the encoded streams of real-time moving image content under control of the control unit 11. After recoding the encoded streams of real-time moving image content, the encoded stream converting unit 14 transmits the recoded encoded streams of real-time moving image content to the encoded stream transmitting unit 15 under control of the control unit 11.

The encoded stream transmitting unit 15 causes the network transmitting and receiving unit 16 to transmit the encoded streams of real-time moving image content transmitted from the encoded stream converting unit 14 using a protocol such as a TCP or an RTP, under control of the control unit 11. The network transmitting and receiving unit 16 receives data from the network 10 and transmits data to the network 10. In this embodiment, the network transmitting and receiving unit receives the encoded streams of real-time moving image content transmitted from the encoded stream transmitting unit 15 and transmits the received encoded streams to the network 10 under control of the control unit 11.

With the configuration shown in FIG. 2 or FIG. 3, the moving image content servers 2 and 3 according to an embodiment of the present disclosure can transmit encoded streams suitable for composite of a plurality of encoded streams in the client terminal 100 to the client terminal 100.

The function configuration examples of the moving image content servers 2 and 3 according to an embodiment of the present disclosure have been described above with reference to FIGS. 2 and 3. Next, a function configuration example of the client terminal 100 according to an embodiment of the present disclosure will be described. First, the function configuration example of the client terminal 100 when a plurality of encoded streams are simply combined to be reproduced will be described. Subsequently, a phenomenon that can be generated when a plurality of encoded streams are simply combined to be reproduced will be described. Following the description of the phenomenon, a function configuration example of the client terminal 100 for solving the phenomenon will be described.

### Function Configuration Example of Client Terminal

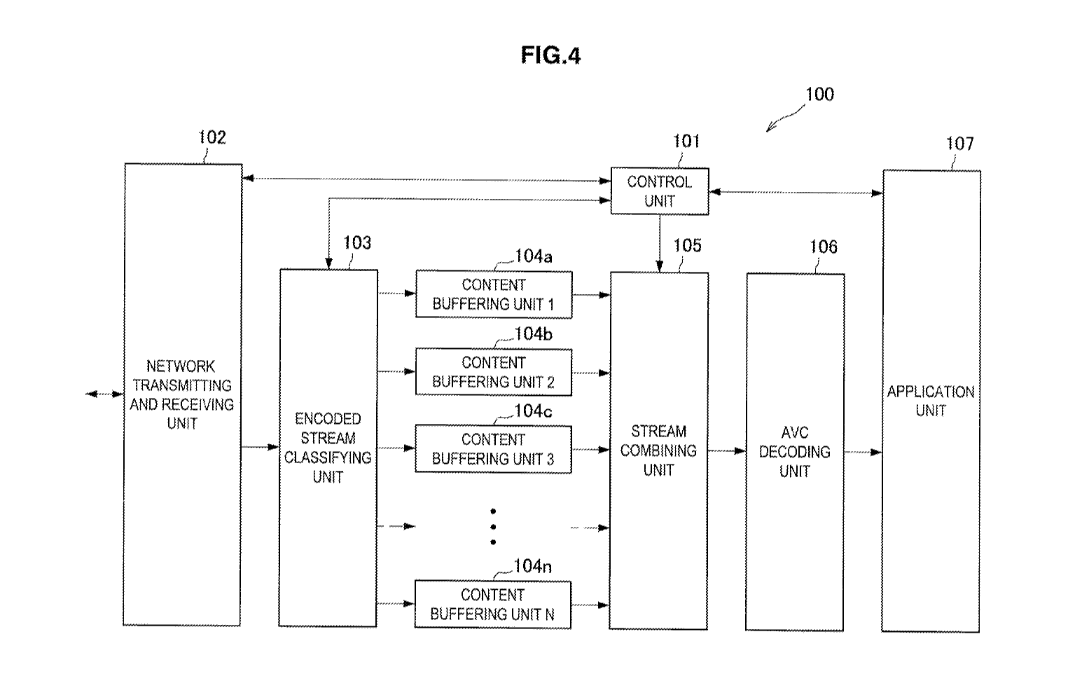

FIG. 4 shows a function configuration example of the client terminal 100 according to an embodiment of the present disclosure. FIG. 4 shows an example of the client terminal 100 having a configuration for simply combining and reproducing encoded streams transmitted from the moving image content servers 2 and 3. The function configuration example of the client terminal 100 according to an embodiment of the present disclosure will be described below with reference to FIG. 4.

As shown in FIG. 4, the client terminal 100 according to an embodiment of the present disclosure includes a control unit 101, a network transmitting and receiving unit 102, an encoded stream classifying unit 103, content buffering units 104a, 104b, 104c, . . . , 104n, a stream combining unit 105, an AVC decoding unit 106, and an application unit 107.

The control unit 101 controls operation of each element in the client terminal 100. The network transmitting and receiving unit 102 receives data from the network 10 and transmits data to the network 10 under control of the control unit 101. In this embodiment, the network transmitting and receiving unit 102 receives the encoded streams transmitted from the moving image content servers 2 and 3. The network transmitting and receiving unit 102 outputs the received encoded streams to the encoded stream classifying unit 103 in accordance with control of the control unit 101. Since the network transmitting and receiving unit 102 can receive a plurality of encoded streams simultaneously, when a plurality of encoded streams are received, the plurality of encoded streams are classified by the encoded stream classifying unit 103 in a latter stage.

The encoded stream classifying unit 103 classifies the encoded streams that the network transmitting and receiving unit 102 has received, in moving image content unit. As described above, since the network transmitting and receiving unit 102 can receive a plurality of encoded streams simultaneously, when a plurality of encoded streams are received, the encoded stream classifying unit 103 classifies the plurality of encoded streams in moving image content unit. The encoded stream classifying unit 103 can classify the encoded streams in moving image content unit by referring to information for identifying content contained in the received encoded streams, for example. After classifying the encoded streams in moving image content unit, the encoded stream classifying unit 103 outputs the classified encoded streams to the content buffering units 104a, 104b, 104c, . . . , 104n in moving image content unit.

The content buffering units 104a, 104b, 104c, . . . , 104n each hold, in moving image content unit, the encoded streams classified by the encoded stream classifying unit 103 in moving image content unit. The encoded streams held in the respective content buffering units 104a, 104b, 104c, . . . , 104n in moving image content unit are output to the stream combining unit 105.

The stream combining unit 105 extracts and combines the encoded streams held in moving image content unit in each of the content buffering units 104a, 104b, 104c, . . . , 104n under control of the control unit 101. The stream combining unit 105 rewrites slice headers of encoded streams of a plurality of moving image content items to combine the plurality of encoded streams as one. After combining the plurality of encoded streams as one, the stream combining unit 105 outputs the combined encoded stream to the AVC decoding unit 106.

An example of a composite process in the stream combining unit 105 will be described. The stream combining unit 105 recognizes, from encoded streams of a plurality of moving image content items, a data length I of a network abstraction layer (NAL) unit of a slice and a number sx of macro blocks of a slice. Then, based on the data length I, the number sx of macro blocks, and arrangement of the plurality of moving image content items in a reproduction image, the stream combining unit 105 rewrites the slice headers of encoded streams of the plurality of moving image content items.

Further, the stream combining unit 105 acquires, from the NAL unit of a picture parameter set (PPS) included in each encoded stream of the plurality of moving image content items supplied from the content buffering units 104a, 104b, 104c, . . . , 104n, a reversible encoding system flag representing a reversible encoding system. Here, examples of the reversible encoding system include context-adaptive variable length coding (CAVLC) and context-adaptive binary arithmetic coding (CABAC). Further, the reversible encoding system flag is 1 when representing CABAC and is 0 when representing CAVLC.

Based on the reversible encoding system flag, the stream combining unit 105 performs a predetermined process on slice data of each encoded stream of the plurality of moving image content items whose slice headers are rewritten. Further, based on arrangement of the plurality of moving image content items in the reproduction image, the stream combining unit 105 combines the encoded streams of moving image content items including the slice data that has been subjected to the above-described predetermined process and the rewritten slice header, thereby generating encoded streams of the reproduction image for reproducing the plurality of moving image content items as one image.

The AVC decoding unit 106 decodes the encoded streams that have been combined as one by the stream combining unit 105 under control of the control unit 101. By decoding the encoded streams that have been combined as one by the stream combining unit 105, the AVC decoding unit 106 can generate and output the reproduction image for reproducing the plurality of moving image content items as one image. The AVC decoding unit 106 outputs the decoded data to the application unit 107.

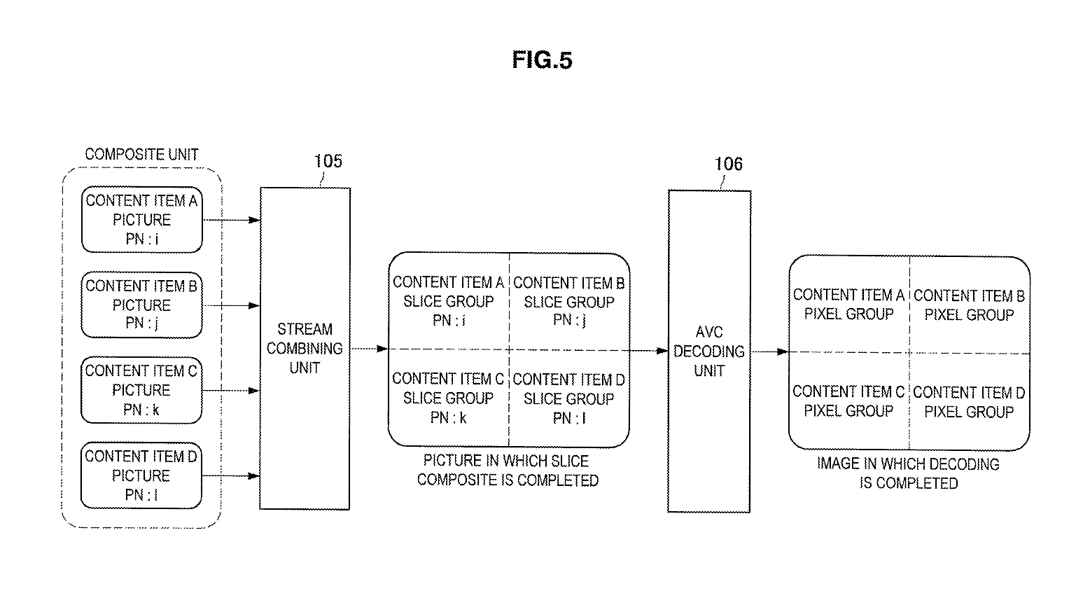

Here, a process of combining the plurality of encoded streams in the stream combining unit 105 will be specifically described. FIG. 5 shows the process of combining the plurality of encoded streams in the stream combining unit 105. FIG. 5 shows the process of combining encoded streams of four moving image content items: moving image content items A to D. FIG. 5 shows an example in which the stream combining unit 105 combines a picture whose picture number PN of the moving image content item A is i, a picture whose picture number PN of the moving image content item B is j, a picture whose picture number PN of the moving image content items C is k, and a picture whose picture number PN of the moving image content items D is l.

Encoded streams of the four moving image content items A to D are combined by the stream combining unit 105, and then encoded streams are output from the stream combining unit 105 as one picture in which slice composite is completed. The encoded streams that have become one picture are decoded by the AVC decoding unit 106 to be output from the AVC decoding unit 106 as pixel groups of the respective moving image content items A to D.

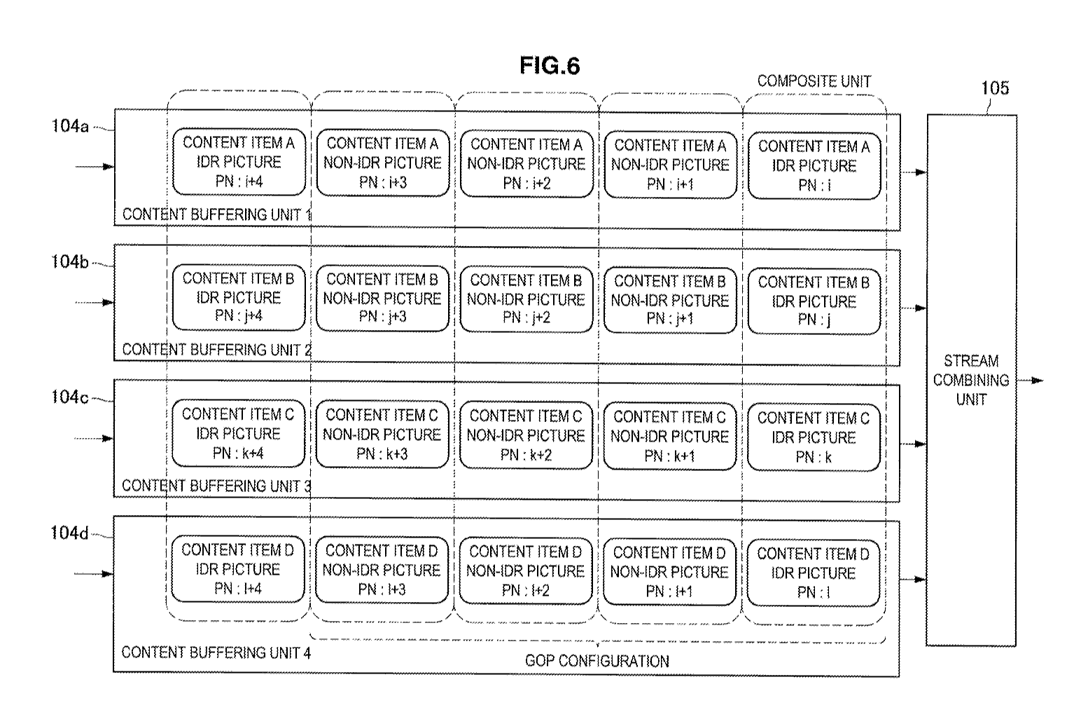

FIG. 6 shows a process of combining a plurality of encoded streams in the stream combining unit 105. FIG. 6 also shows the content buffering units 104a, 104b, 104c, and 104d. When combining the plurality of encoded streams, the stream combining unit 105 arranges GOP configurations of all the encoded streams. That is, as shown in FIG. 6, composite is performed such that pictures in composite unit are the same kinds of pictures (IDR pictures or non-IDR pictures).

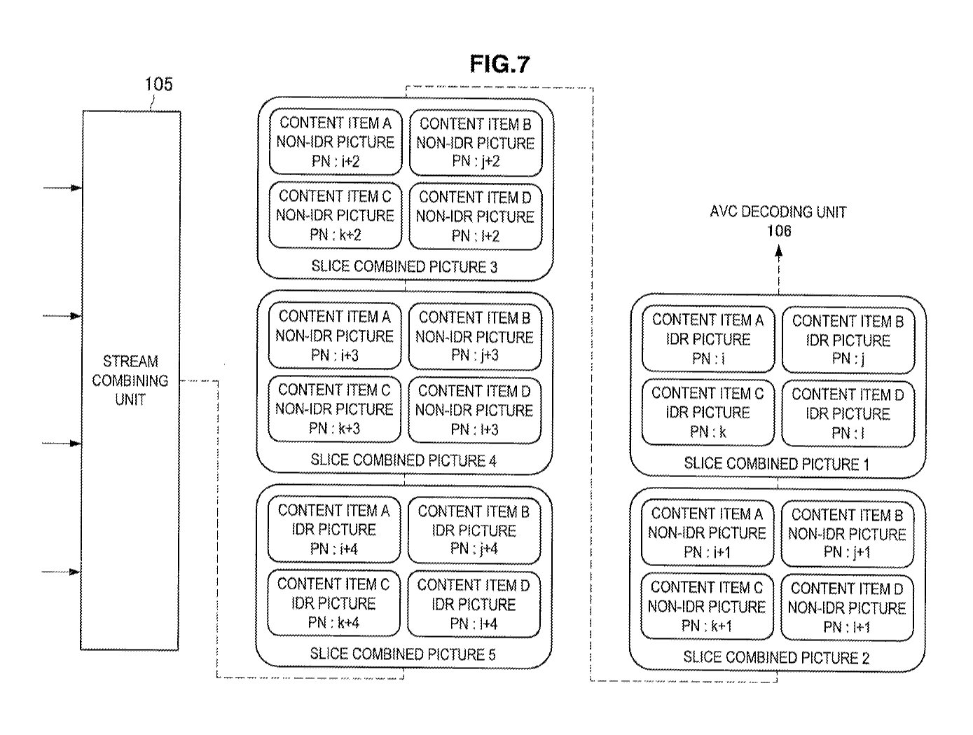

FIG. 7 shows the state of the plurality of encoded streams that are combined in the stream combining unit 105. After the encoded streams of the four moving image content items A to D are combined (slice combined) in picture unit in the stream combining unit 105, as shown in FIG. 7, the combined encoded streams are output from the stream combining unit 105 in picture unit and transmitted to the AVC decoding unit 106.

By arranging the kinds of pictures and decoding the combined encoded streams that are transmitted from the stream combining unit 105 in this manner, the AVC decoding unit 106 can generate an image having pixel groups of the respective moving image content items A to D.

The application unit 107 executes application that is executed by the client terminal 100. The application unit 107 acquires data output from the AVC decoding unit 106. The application unit 107 then can display an image, obtained by decoding, on a display screen, or transfer the image to another device having a display screen, under control of the control unit 101.

The client terminal 100 according to an embodiment of the present disclosure has the configuration shown in FIG. 4; therefore, it is possible to combine and decode encoded streams transmitted from the moving image content servers 2 and 3 by arranging the kinds of the pictures to reproduce a plurality of moving image content items on one screen.

At the same time, the client terminal 100 can generate a phenomenon described below because of the configuration shown in FIG. 4.

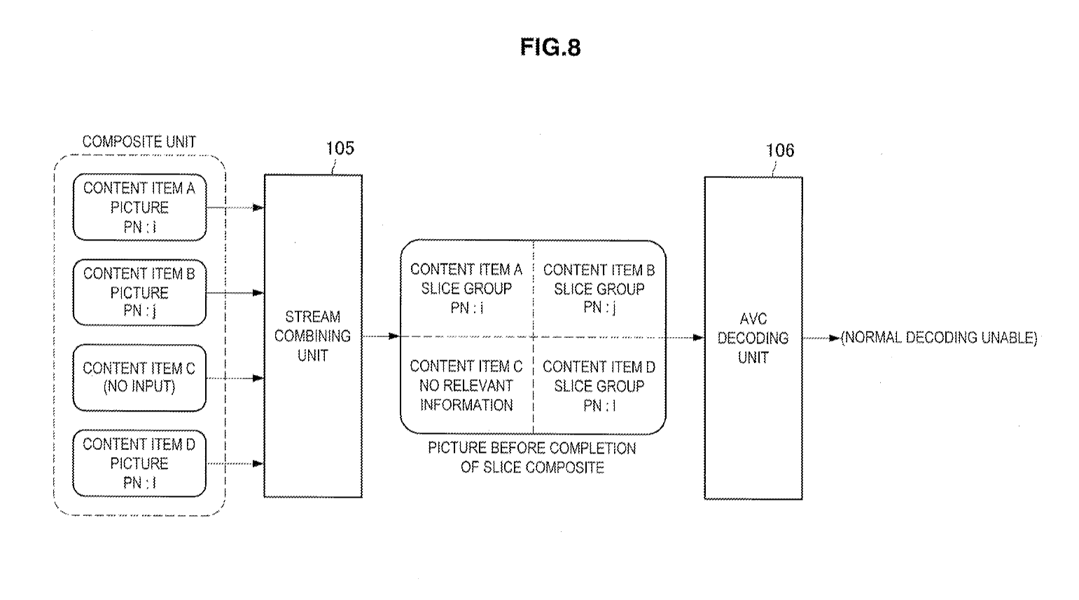

FIG. 8 shows a process of combining a plurality of encoded streams in the stream combining unit 105. FIG. 8 shows the process of combining encoded streams of the four moving image content items A to D as in the example shown in FIG. 5. However, FIG. 8 shows a case where, although the stream combining unit 105 is to combine a picture whose picture number PN of the moving image content item A is i, a picture whose picture number PN of the moving image content item B is j, and a picture whose picture number PN of the moving image content items D is l, encoded streams of the moving image content item C are not input for some reason.

A variety of reasons can be assumed why the encoded streams of the moving image content item C are not input. For example, the following cases can be given: a packet is lost by an obstacle generated in the transmission path from the moving image content servers 2 and 3 to the client terminal 100, or a target picture does not exist because the arrival of the packet is delayed from the moving image content servers 2 and 3 to the client terminal 100.

When encoded streams of one moving image content item are not input in this manner, as shown in FIG. 8, slice composite of encoded streams is failed in the stream combining unit 105. This is because the stream combining unit 105 fails to complete one picture. When the slice composite of encoded streams is failed, normal decoding is also unable in the AVC decoding unit 106. Accordingly, when only one moving image content item is not input, there could be generated the phenomenon that the other (three in the example in FIG. 8) moving image content items are not reproduced and displayed.

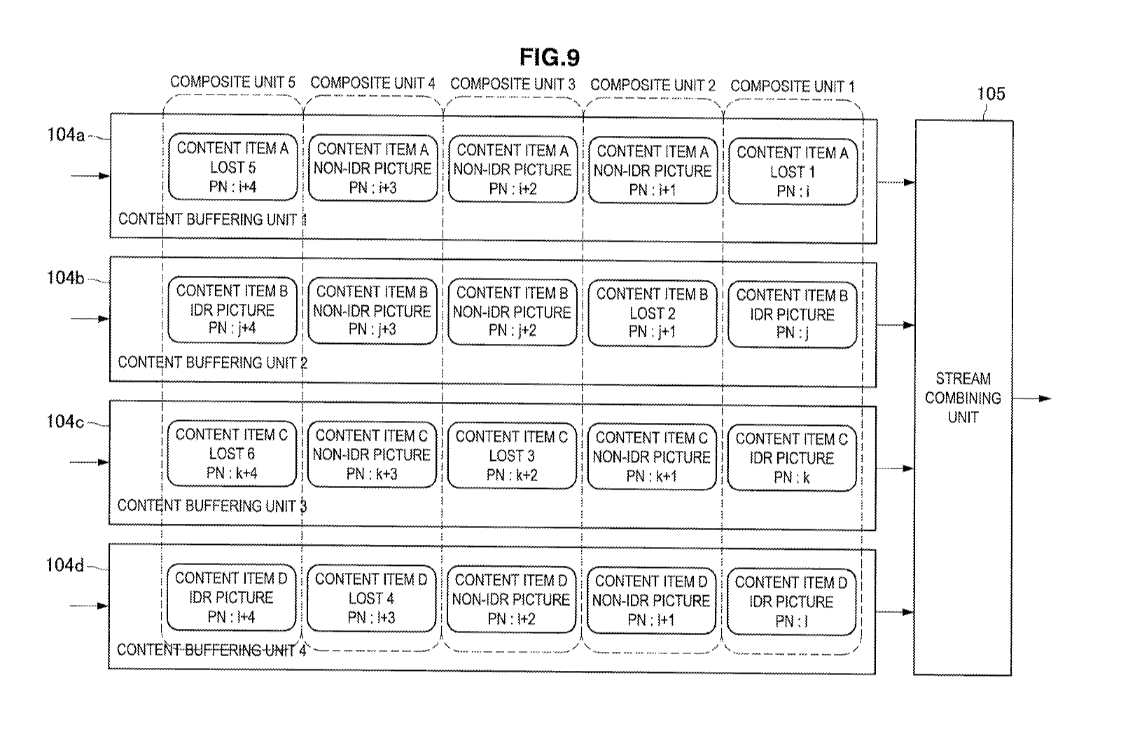

FIG. 9 shows a process of combining a plurality of encoded streams in the stream combining unit 105. FIG. 9 shows the process of combining encoded streams of the four moving image content items A to D as in the example shown in FIG. 6. However, FIG. 9 shows a state where some pictures are lost in encoded streams of at least one of the moving content items A to D when the encoded streams of the four moving image content items A to D are combined in the stream combining unit 105.

For example, FIG. 9 shows a case where the content buffering unit 104b stores an IDR picture whose picture number PN of the moving image content item B is j, the content buffering unit 104c stores an IDR picture whose picture number PN of the moving image content item C is k, and the content buffering unit 104d stores an IDR picture whose picture number PN of the moving image content item D is l, but the content buffering unit 104a does not store an IDR picture whose picture number PN of the moving image content item A is because the IDR picture is not input for some reason. In this state, the stream combining unit 105 fails to slice combine encoded streams of the four moving image content items A to D. This is because the stream combining unit 105 fails to complete one picture.

In encoded streams of at least one of the moving image content items A to D, a picture loss in this manner is generated over a plurality of pictures, the stream combining unit 105 fails to slice combine encoded streams while the pictures are lost.

Accordingly, this embodiment shows the client terminal 100 that can perform simultaneous reproduction and display of a plurality of moving image content items even when a picture is lost in encoded streams of any of moving image content items in this manner.

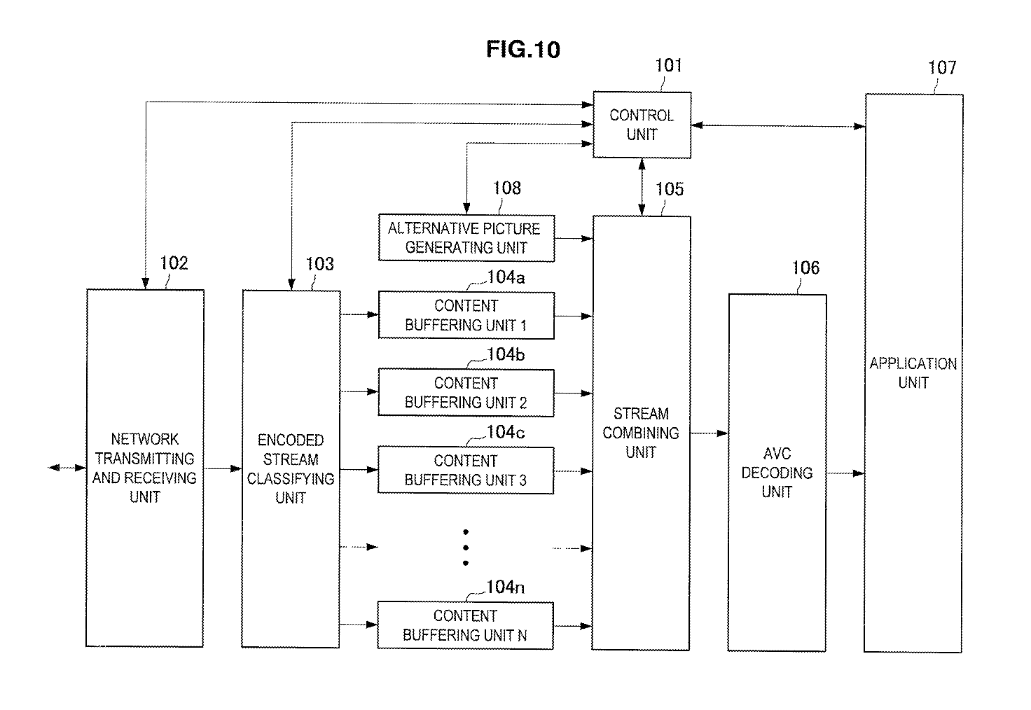

FIG. 10 shows a function configuration example of the client terminal 100 according to an embodiment of the present disclosure. FIG. 10 shows the example of the client terminal 100 having a configuration for combining and reproducing encoded streams transmitted from the moving image content servers 2 and 3. The function configuration example of the client terminal 100 according to an embodiment of the present disclosure will be described below with reference to FIG. 10.

As shown in FIG. 10, the client terminal 100 according to an embodiment of the present disclosure includes the control unit 101, the network transmitting and receiving unit 102, the encoded stream classifying unit 103, the content buffering units 104a, 104b, 104c, . . . , 104n, the stream combining unit 105, the AVC decoding unit 106, the application unit 107, and an alternative picture generating unit 108.

In the configuration of the client terminal 100 shown in FIG. 10, configuration other than the alternative picture generating unit 108 is the same as that of the client terminal 100 shown in FIG. 4; therefore, a detailed description thereof is omitted here and the alternative picture generating unit 108 will be described in detail.

When there is a loss in encoded streams of a plurality of moving image content items received by the client terminal 100, the alternative picture generating unit 108 generates an alternative picture under control of the control unit 101 so that the lost portion can be replaced by another picture (also called an alternative picture).

The alternative picture generating unit 108 can generate different alternative pictures depending on kinds of lost pictures. For example, when the lost picture is an IDR picture, the alternative picture generating unit 108 may set, as the alternative picture, an IDR picture that is normally received as the final picture in the relevant encoded stream. When the lost picture is a P picture, the alternative picture generating unit 108 may set, as the alternative picture, a P picture using a skipped macro block.

The stream combining unit 105, which extracts encoded streams from the content buffering units 104a, 104b, 104c, . . . , 104n, determines whether or not a loss is generated in encoded streams. When a loss in encoded streams is detected during the composite of encoded streams of a plurality of moving image content items, the stream combining unit 105 notifies, of the control unit 101, information of the moving image content item corresponding to the encoded stream including the loss and the kind of the lost picture.

The stream combining unit 105 can determine whether or not the loss is generated in encoded streams by determining whether or not picture numbers of pictures stored in the content buffering units 104a, 104b, 104c, . . . , 104n are output to the stream combining unit 105 in a correct order, for example.

After receiving the notification of the loss in received encoded streams from the stream combining unit 105, the control unit 101 notifies the loss of the alternative picture generating unit 108. The alternative picture generating unit 108 generates an alternative picture corresponding to the loss and outputs the generated alternative picture to the stream combining unit 105. The stream combining unit 105 replaces the lost picture by the alternative picture transmitted from the alternative picture generating unit 108 and performs slice composite.

With the above configuration, the client terminal 100 according to an embodiment of the present disclosure can simultaneously reproduce and display a plurality of moving image content items even when a picture is lost in encoded streams of any of the moving image content items, by performing composite by replacing the lost picture by an alternative picture.

Note that the moving image content servers 2 and 3, instead of the client terminal 100, may generate the alternative picture. When the moving image content servers 2 and 3 generate the alternative picture, the moving image content servers 2 and 3 transmit, in addition to encoded streams of moving image content, encoded streams in which the alternative picture is encoded. A configuration example where the moving image content servers 2 and 3 generate the alternative picture will be described.

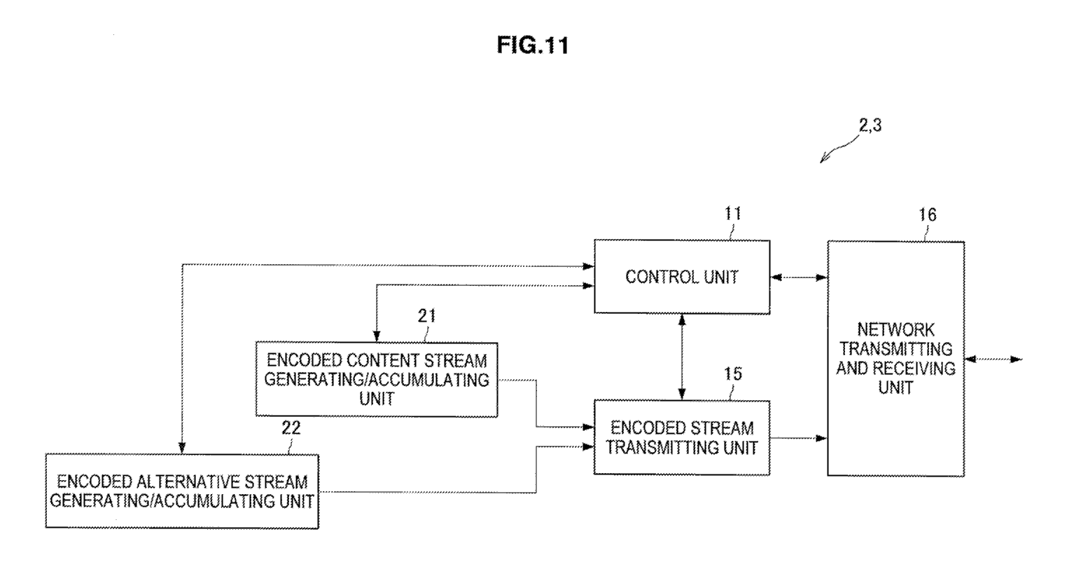

FIG. 11 shows a function configuration example of the moving image content servers 2 and 3 according to an embodiment of the present disclosure. FIG. 11 shows the function configuration example of the moving image content servers 2 and 3 when the moving image content servers 2 and 3 generate the alternative picture.

As shown in FIG. 11, the moving image content servers 2 and 3 according to an embodiment of the present disclosure include the control unit 11, the encoded stream transmitting unit 15, the network transmitting and receiving unit 16, an encoded content stream generating/accumulating unit 21, and an encoded alternative stream generating/accumulating unit 22.

The encoded content stream generating/accumulating unit 21 generates and accumulates encoded streams that are to be transmitted to the client terminal 100. The encoded content stream generating/accumulating unit 21 can include the processed encoded stream accumulating unit 12 shown in FIG. 2 and the encoded stream-to-be-processed accumulating unit 13 and the encoded stream converting unit 14 shown in FIG. 3.

When a loss is generated in part of encoded streams in transmission of the encoded streams to the client terminal 100, the encoded alternative stream generating/accumulating unit 22 generates and accumulates streams serving as a base of the alternative picture generated in the client terminal 100. The streams generated in the encoded alternative stream generating/accumulating unit 22 have the same GOP as the other encoded streams.

With the configuration shown in FIG. 11, the moving image content servers 2 and 3 can generate and accumulate the alternative picture. Further, with the configuration shown in FIG. 11, the moving image content servers 2 and 3 can transmit encoded streams including the alternative picture to the client terminal 100.

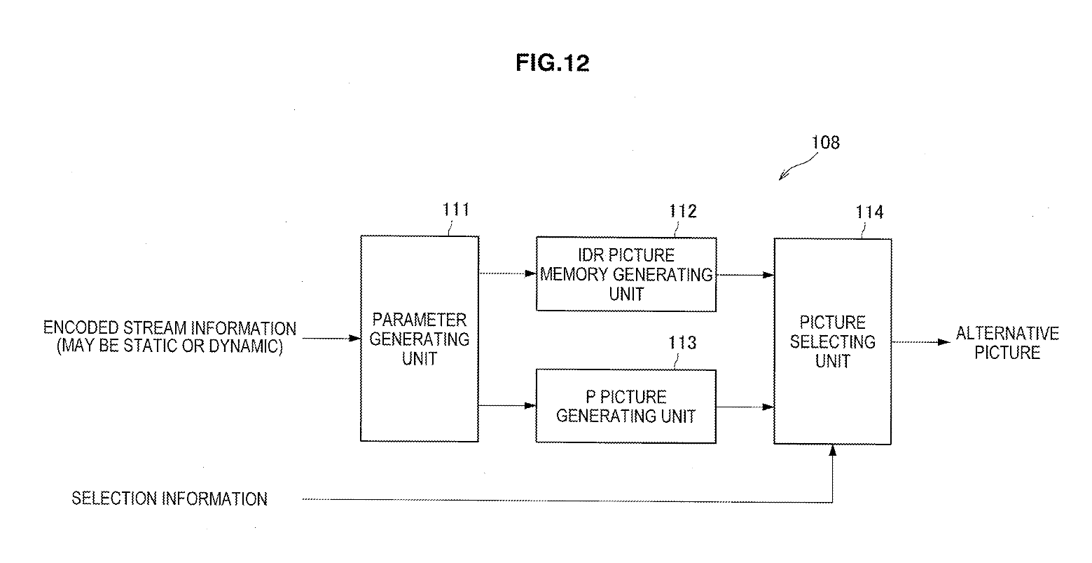

Subsequently, a function configuration example of the alternative picture generating unit 108 included in the client terminal 100 according to an embodiment of the present disclosure will be described. FIG. 12 shows the function configuration example of the alternative picture generating unit 108 included in the client terminal 100 according to an embodiment of the present disclosure.

As shown in FIG. 12, the alternative picture generating unit 108 includes a parameter generating unit 111, an IDR picture memory generating unit 112, a P picture generating unit 113, and a picture selecting unit 114.

The parameter generating unit 111 generates parameters for generating the alternative picture from encoded streams of moving image content transmitted from the moving image content servers 2 and 3. After generating the parameters for generating the alternative picture from encoded streams of moving image content, the parameter generating unit 111 outputs the generated parameters to the IDR picture memory generating unit 112 and the P picture generating unit 113.

When the alternative picture is an IDR picture, the IDR picture memory generating unit 112 acquires an IDR picture serving as a base of the alternative picture from encoded streams of moving image content to store the IDR picture, stores a fixed IDR picture, or generates a given IDR picture. The IDR picture memory generating unit 112 generates the IDR picture serving as a base of the alternative picture based on the parameters output from the parameter generating unit 111. A configuration example of the IDR picture memory generating unit 112 will be described later. The IDR picture memory generating unit 112 outputs the IDR picture serving as a base of the alternative picture to the picture selecting unit 114.

When the alternative picture is a P picture, the P picture generating unit 113 generates a P picture serving as a base of the alternative picture. The P picture generating unit 113 generates a P picture serving as a base of the alternative picture based on the parameters output from the parameter generating unit 111. The P picture generating unit 113 outputs the P picture serving as a base of the alternative picture to the picture selecting unit 114.

In this embodiment, the P picture generating unit 113 generates a P picture using a skipped macro block based on the parameters output from the parameter generating unit 111. Note that in a case of using MPEG-4, the P picture generating unit 113 generates the P picture by using the same pixel of a reference frame as the skipped macro block. In a case of using H.264/AVC, the P picture generating unit 113 generates the P picture by using a predictive motion vector and a motion compensation predicted signal as the skipped macro block.

The picture selecting unit 114 selects either the IDR picture output from the IDR picture memory generating unit 112 or the P picture output from the P picture generating unit 113 and set the selected picture as the alternative picture. The selection of the IDR picture or the P picture is based on selection information transmitted to the picture selecting unit 114. That is, the picture selecting unit 114 selects either the IDR picture or the P picture depending on whether the IDR picture or the P picture is lost.

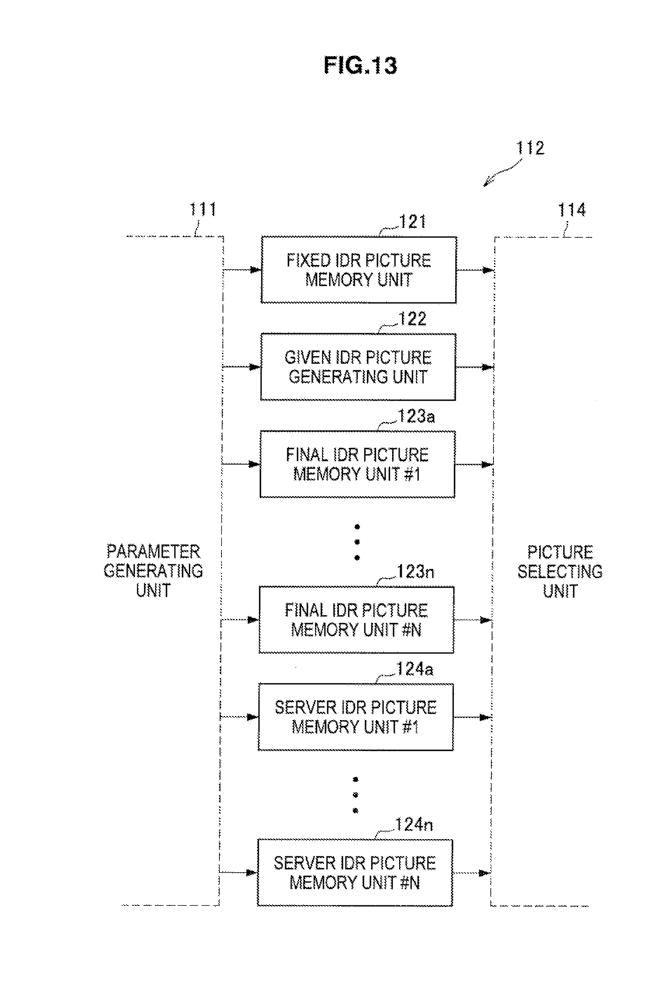

Next, a configuration example of the IDR picture memory generating unit 112 will be described. FIG. 13 shows the configuration example of the IDR picture memory generating unit 112 included in the alternative picture generating unit 108.

As shown in FIG. 13, the IDR picture memory generating unit 112 includes a fixed IDR picture memory unit 121, a given IDR picture generating unit 122, final IDR picture memory units 123a to 123n, and server IDR picture memory units 124a to 124n.

When the IDR picture is lost and a fixed picture is used as the alternative picture, the fixed IDR picture memory unit 121 stores the fixed IDR picture. Examples of the IDR picture stored in the fixed IDR picture memory unit 121 include a picture for displaying a specific image or character.

When the IDR picture is lost and a given picture is used as the alternative picture, the given IDR picture generating unit 122 generates the given IDR picture. Examples of the given IDR picture include a picture for displaying an image or character generated in accordance with the state of the client terminal 100.

When the IDR picture is lost and a latest IDR picture is used as the alternative picture in encoded streams of moving image content transmitted from the moving image content servers 2 and 3, the final IDR picture memory units 123a to 123n stores the latest (final) IDR picture.

The number of the final IDR picture memory units 123a to 123n may be the same as the number of the content buffering units 104a to 104n. That is, the final IDR picture of the moving image content item A can be stored in the final IDR picture memory unit 123a and the final IDR picture of the moving image content item N can be stored in the final IDR picture memory unit 123n.

When the IDR picture is lost and an IDR picture is used as the alternative picture in encoded streams for the alternative picture transmitted from the moving image content servers 2 and 3, the server IDR picture memory units 124a to 124n store the IDR picture in the encoded streams for the alternative picture transmitted from the moving image content servers 2 and 3.

The number of the server IDR picture memory units 124a to 124n may be the same as the number of the content buffering units 104a to 104n. That is, the IDR picture for the alternative picture corresponding to the moving image content item A can be stored in the server IDR picture memory unit 124a and the IDR picture for the alternative picture corresponding to the moving image content item N can be stored in the server IDR picture memory unit 124n.

The user of the client terminal 100 can select the IDR picture to be used as the alternative picture.

With this configuration, even when a picture is lost in encoded streams of one of moving image content items, the client terminal 100 according to an embodiment of the present disclosure can generate an alternative picture or replace the lost picture by an alternative picture acquired from the moving image content servers 2 and 3, so that composite is performed. The client terminal 100 according to an embodiment of the present disclosure performs composite by replacing the lost picture by the alternative picture, thereby continuously performing simultaneous reproduction and display of a plurality of moving image content items even when a picture is lost in encoded streams of one of the moving image content items.

The function configuration example of the client terminal 100 according to an embodiment of the present disclosure has been described above. Next, an operation example of the client terminal 100 according to an embodiment of the present disclosure will be described.

### Operation Example of Client Terminal

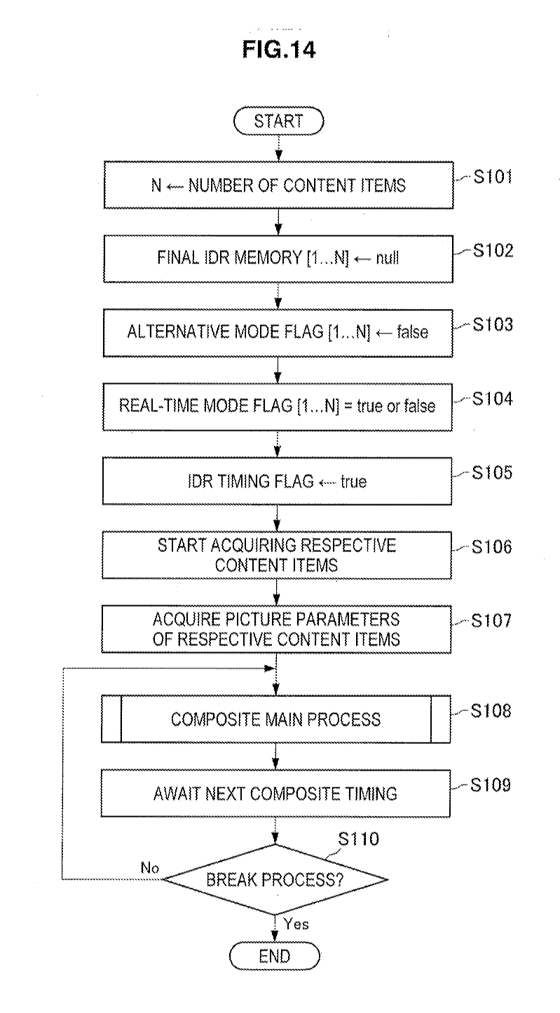

FIG. 14 is a flow chart showing an operation example of the client terminal 100 according to an embodiment of the present disclosure. FIG. 14 shows processes in which the client terminal 100 receives a plurality of encoded streams from the moving image content servers 2 and 3 and combines and encodes a picture to simultaneously reproduce a plurality of moving image content items. The operation example of the client terminal 100 according to an embodiment of the present disclosure will be described below with reference to FIG. 14.

First, the client terminal 100 executes initial setting to simultaneously reproduce a plurality of moving image content items (steps S101 to S105). The control unit 101 can execute the initial setting in steps S101 to S105. The client terminal 100 sets the number of moving image content items that are to be simultaneously reproduced, as a variable N (step S101). Further, the client terminal 100 sets buffers (the final IDR picture memory units 123a to 123n) holding the final IDR pictures of the respective moving image content items, as null (step S102).

Further, the client terminal 100 sets an alternative mode flag with respect to the respective moving image content items, as false (step S103) and sets a flag regarding whether or not the respective moving image content items are distributed in real time (step S104). Then, the client terminal 100 sets an IDR timing flag for identifying whether or not the current picture is an IDR picture, as true (step S105).

Note that the alternative mode flag is a flag for generating an alternative picture owing to a loss of a picture and for determining whether or not the alternative picture is used for a composite process.

After executing the initial setting to simultaneously reproduce a plurality of moving image content items in steps S101 to S105, the client terminal 100 starts acquiring the moving image content items from the moving image content servers 2 and 3 (step S106). Then, after starting acquiring the moving image content items from the moving image content servers 2 and 3, the client terminal 100 acquires picture parameters of the respective moving image content items (step S107).

After acquiring picture parameters of the respective moving image content items, the client terminal 100 executes a composite main process, in picture unit, in which the plurality of moving image content items are combined using the picture parameters of the respective acquired moving image content items (step S108). The stream combining unit 105 executes the composite main process. Note that an overview of the composite main process will be described later in detail.

After executing the composite main process in which the plurality of moving image content items are combined, the client terminal 100 awaits the next composite timing (step S109) and determines whether or not to break the composite process (step S110). When the composite process will be broken, the client terminal 100 continues the composite main process in step S108; when the composite process will be broken, the client terminal 100 ends the series of processes.

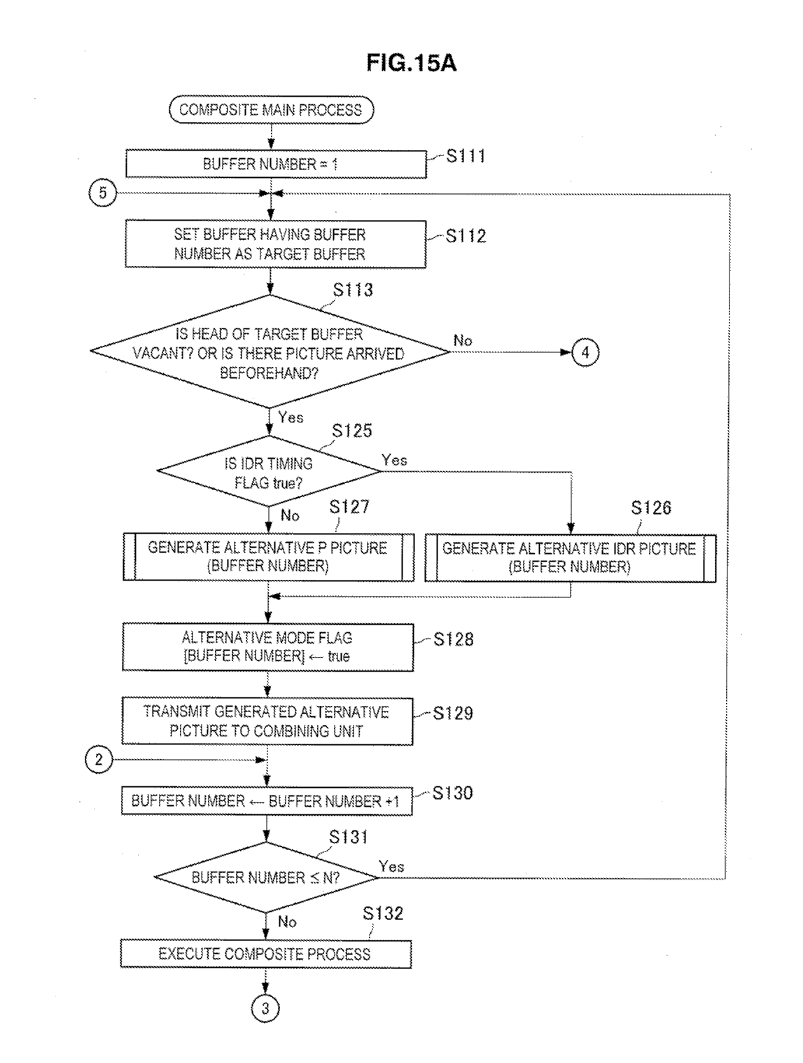

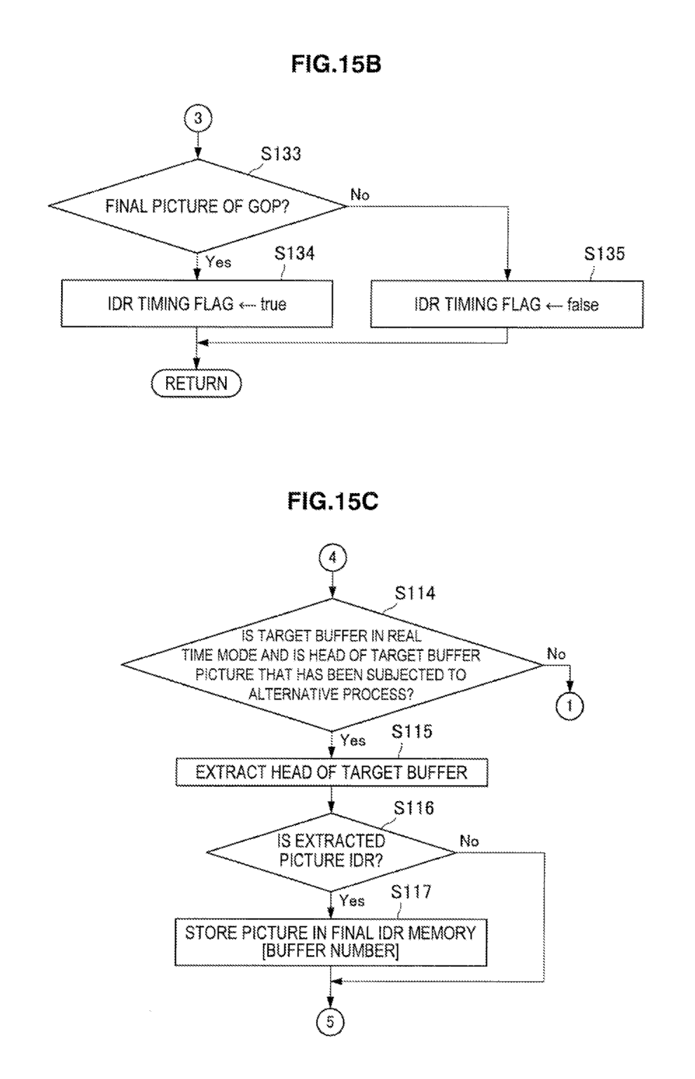

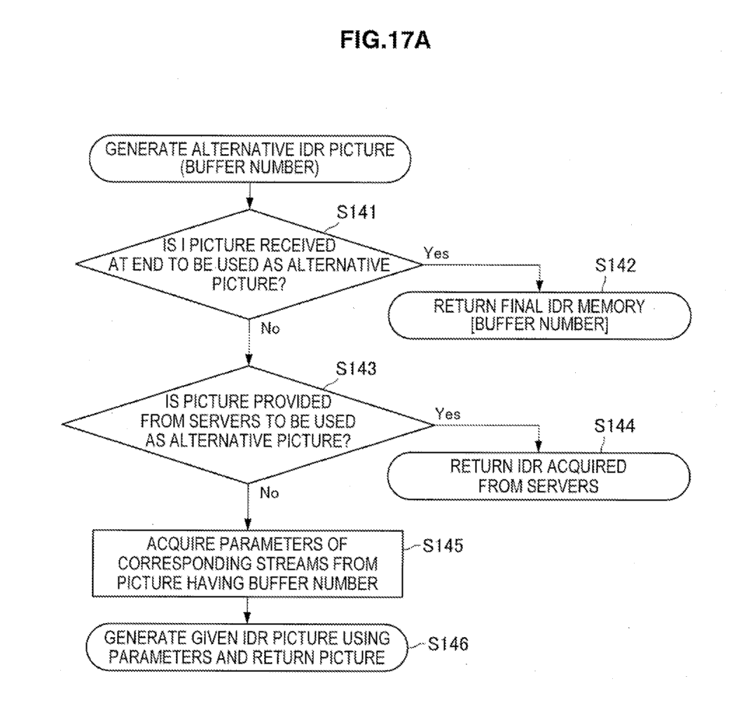

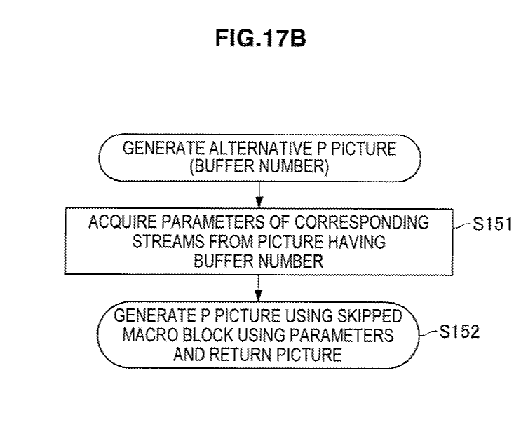

Next, the composite main process shown in step S108 in FIG. 14 will be described in detail. FIGS. 15A to 17B are flow charts showing operation examples of the client terminal 100 according to an embodiment of the present disclosure. FIGS. 15A to 17B show a detailed flow of the composite main process shown in step S108 in FIG. 14. The operation examples of the client terminal 100 according to an embodiment of the present disclosure will be described below with reference to FIGS. 15A to 17B.

When the composite main process is executed, first, the client terminal 100 sets a buffer number to 1 (step S111). The control unit 101 can execute the process in step S111. After setting the buffer number to 1, the client terminal 100 sets the buffer having the buffer number as a process target buffer (step S112). The control unit 101 can execute the process in step S112. That is, when the buffer number is 1, the content buffering unit 104a is set as the process target buffer.

Next, the client terminal 100 determines whether the head of the process target buffer is vacant or whether there is a picture that has arrived beforehand (step S113). The control unit 101 can execute the determination process in step S113.

As a result of the determination in step S113, when the head of the process target buffer is not vacant and no picture has arrived beforehand, the client terminal 100 determines whether the target buffer is to store encoded streams of moving image content items that are distributed in real time (having the real time mode flag of true) and whether the head of the target buffer is a picture that has been subjected to an alternative process (step S114). The control unit 101 can execute the determination process in step S114.

As a result of the determination in step S114, when the target buffer is to store encoded streams of moving image content items that are distributed in real time and the head of the target buffer is the picture that has been subjected to the alternative process, the client terminal 100 extracts the picture at the head of the target buffer (step S115). The control unit 101 can cause the stream combining unit 105 to execute the process in step S115.

Since the target buffer stores the movie content items that are distributed in real time, when the picture that has been subjected to the alternative process (i.e., a picture that has arrived late) exists at the head of the target buffer, in order to maintain the time axis, the client terminal 100 extracts the picture that has arrived late (the picture at the head of the buffer) so as not to use this picture for the composite process.

After extracting the picture at the head of the target buffer in step S115, the client terminal 100 determines whether or not the extracted picture is an IDR picture (step S116). The control unit 101 can execute the determination process in step S116.

As a result of the determination in step S116, when the extracted picture is an IDR picture, the client terminal 100 stores the extracted IDR picture in one of the final IDR picture memory units 123a to 123n, the one corresponding to the buffer number (in the final IDR picture memory unit 123a when the buffer number is 1) (step S117). The control unit 101 can execute the process in step S117. When the extracted picture is an IDR picture and the picture is not to be used for the composite process, the picture may possibly be used in the subsequent alternative process of pictures; accordingly, the client terminal 100 stores the extracted IDR picture in one of the final IDR picture memory units 123a to 123n, the one corresponding to the buffer number.

Meanwhile, as a result of the determination in step S116, when the extracted picture is a P picture, the client terminal 100 skips the process in step S117.

After storing the extracted IDR picture to the one of the final IDR picture memory units 123a to 123n, the one corresponding to the buffer number (or skipping the storing process), the client terminal 100 returns to the process in step S112.

Meanwhile, as a result of the determination in step S114, when the target buffer is not to store encoded streams of moving image content items that are distributed in real time or when the head of the target buffer does not contain the picture that has been subjected to the alternative process, the client terminal 100 extracts a picture at the head of the target buffer (step S118). The control unit 101 can cause the stream combining unit 105 to execute the process in step S118.

After extracting the picture at the head of the target buffer in step S118, the client terminal 100 determines whether or not an IDR timing flag is true (step S119). The control unit 101 can execute the determination process in step S119.

As a result of the determination in step S119, when the IDR timing flag is true, the client terminal 100 stores the IDR picture extracted in step S118 in one of the final IDR picture memory units 123a to 123n, the one corresponding to the buffer number (in the final IDR picture memory unit 123a when the buffer number is 1) (step S120). The control unit 101 can execute the process in step S120.

After storing the extracted IDR picture in the one of the IDR picture memory units 123a to 123n, the one corresponding to the buffer number, the client terminal 100 sets an alternative mode flag corresponding to the buffer of the process target, as false (step S121). The control unit 101 can execute the process in step S121.

Meanwhile, as a result of the determination in step S119, when the IDR timing flag is not true (i.e., when the IDR timing flag is false), the client terminal 100 does not execute the processes in steps S120 and S121 but determines whether or not the alternative mode flag corresponding to the buffer that is the process target is true (step S122). The control unit 101 can execute the determination process in step S122.

As a result of the determination in step S122, when the alternative mode flag corresponding to the process target buffer is true, the client terminal 100 generates an alternative picture to the P picture with respect to encoded streams corresponding to the buffer (step S123). The alternative picture generating unit 108 can execute the process in step S123. Reasons why the alternative picture to the P picture is generated here will be described later in detail, but a brief description is as follows.

The alternative mode flag being true at this point means that the precedent IDR picture has been lost and the process of generating the alternative picture has been executed. The P picture is dependent on information of the IDR picture in the same precedent GOP. Therefore, even when the P picture is normally received, as long as the alternative picture to the IDR picture is generated, the client terminal 100 removes the normally received P picture and replaces the P picture by a P picture using a skipped macro block.

After executing the process in step S121 or S123, the client terminal 100 transmits the picture extracted in step S118 or the alternative picture generated in step S123 to the stream combining unit 105 (step S124). The alternative picture generating unit 108 can execute the process in step S124. After transmitting the picture to the stream combining unit 105 in step S124, the client terminal 100 starts a process in step S130 that will be described later.

As a result of the determination in step S113, when the head of the process target buffer is vacant or there is a picture that has arrived beforehand, the client terminal 100 determines whether or not the IDR timing flag is true (step S125). The control unit 101 can execute the determination process in step S125.

As a result of the determination in step S125, when the IDR timing flag is true, the client terminal 100 determines that an IDR picture is lost and generates an alternative picture serving as an alternative to the IDR picture (an alternative IDR picture) in the alternative picture generating unit 108 (step S126).

Meanwhile, as a result of the determination in step S125, when the IDR timing flag is not true (i.e., when the IDR timing flag is false), the client terminal 100 determines that a P picture is lost and generates an alternative picture serving as an alternative to the P picture (an alternative P picture) in the alternative picture generating unit 108 (step S127). Flows of a process of generating the alternative IDR picture and a process of generating the alternative P picture in the alternative picture generating unit 108 will be described later in detail.

After generating the alternative IDR picture or the alternative P picture in step S126 or S127, the client terminal 100 sets the alternative mode flag corresponding to the process target buffer, as true (step S128). The control unit 101 can execute the process in step S128.

After setting the alternative mode flag corresponding to the process target buffer, as true, in step S128, the client terminal 100 transmits the alternative IDR picture or the alternative P picture generated in step S126 or S127 from the alternative picture generating unit 108 to the stream combining unit 105 (step S129).

After transmitting the alternative IDR picture or the alternative P picture from the alternative picture generating unit 108 to the stream combining unit 105, the client terminal 100 increments the buffer number by one (step S130). The control unit 101 can execute the process in step S130.

After incrementing the buffer number by one, the client terminal 100 determines whether or not the incremented buffer number is smaller than or equal to the number N of content items (step S131). The control unit 101 can execute the determination process in step S131.

As a result of the determination in step S131, when the incremented buffer number is smaller than or equal to the number N of content items, the client terminal 100 returns to the process in step S112. Meanwhile, as a result of the determination in step S131, when the incremented buffer number is larger than the number N of content items, the client terminal 100 executes the composite process of a picture in the stream combining unit 105 (step S132). Since the composite process of a picture has been described above, a detailed description thereof is omitted here.

After executing the composite process of a picture in step S132, the client terminal 100 determines whether or not the current picture is the final picture of the GOP (step S133). The control unit 101 can execute the determination process in step S133.

As a result of the determination in step S133, when the current picture is the final picture of the GOP, the client terminal 100 sets the IDR timing flag as true (step S134). Meanwhile, as a result of the determination in step S133, when the current picture is not the final picture of the GOP, the client terminal 100 sets the IDR timing flag as false (step S135). The control unit 101 can execute the process in step S135.

After setting the IDR timing flag as true or false in step S134 or S135, the client terminal 100 terminates the composite main process and starts the process in step S109 (awaiting the next composite timing).

Next, the process of generating the alternative IDR picture and the process of generating the alternative P picture in the alternative picture generating unit 108 will be described. When generating the alternative IDR picture, first, the client terminal 100 determines whether or not an IDR picture that has been received at the end is to be used as the alternative IDR picture (step S141). The control unit 101 can execute the determination process in step S141.

As a result of the determination in step S141, when the IDR picture that has been received at the end is to be used as the alternative IDR picture, the client terminal 100 returns the IDR picture stored in any of the final IDR picture memory units 123a to 123n to the stream combining unit 105 as the alternative IDR picture (step S142). The alternative picture generating unit 108 can execute the process in step S142.

Meanwhile, as a result of the determination in step S141, when the IDR picture that has been received at the end is not to be used as the alternative IDR picture, the client terminal 100 determines whether or not the IDR picture provided from the moving image content servers 2 and 3 is to be used as the alternative IDR picture (step S143). The control unit 101 can execute the determination process in step S143.

As a result of the determination in step S143, when the IDR picture provided from the moving image content servers 2 and 3 is to be used as the alternative IDR picture, the client terminal 100 returns the IDR picture that has been provided from the moving image content servers 2 and 3 and stored in any of the server IDR picture memory units 124a to 124n to the stream combining unit 105 as the alternative IDR picture (step S144). The alternative picture generating unit 108 can execute the process in step S144.

Meanwhile, as a result of the determination in step S143, when the IDR picture provided from the moving image content servers 2 and 3 is not to be used as the alternative IDR picture, the client terminal 100 acquires parameters of corresponding encoded streams from a picture having the target buffer number (step S145). The control unit 101 can execute the process in step S145.

After acquiring parameters of corresponding encoded streams from a picture having the target buffer number in step S145, the client terminal 100 generates a given IDR picture using the acquired parameters and returns the given IDR picture to the stream combining unit 105 as the alternative IDR picture (step S146). The alternative picture generating unit 108 can execute the process in step S146.

Note that, as a result of the determination in step S143, when the IDR picture provided from the moving image content servers 2 and 3 is not to be used as the alternative IDR picture, the client terminal 100 may return a fixed picture to the stream combining unit 105 as the alternative IDR picture.

When generating the alternative P picture, first, the client terminal 100 acquires parameters of corresponding encoded streams from a picture having the target buffer number (step S151). The control unit 101 can execute the process in step S151.

After acquiring parameters of corresponding encoded streams from a picture having the target buffer number in step S151, the client terminal 100 generates a P picture using a skipped macro block using the acquired parameters and returns the P picture to the stream combining unit 105 as the alternative P picture (step S152). The alternative picture generating unit 108 can execute the process in step S152.

The process of generating the alternative IDR picture and the process of generating the alternative P picture in the alternative picture generating unit 108 have been described above.

By executing the above operations, even when a picture is lost in encoded streams of any of moving image content items, the client terminal 100 according to an embodiment of the present disclosure can generate an alternative picture or acquire an alternative picture from the moving image content servers 2 and 3 and replace the lost picture by the alternative picture acquired from the moving image content servers 2 and 3, so that composite is performed. The client terminal 100 according to an embodiment of the present disclosure replaces the lost picture by the alternative picture to perform composite, thereby continuously performing simultaneous reproduction and display of a plurality of moving image content items even when a picture is lost in encoded streams of any of the moving image content items.

Here, an operation example of the client terminal 100 according to an embodiment of the present disclosure will be described in more detail.

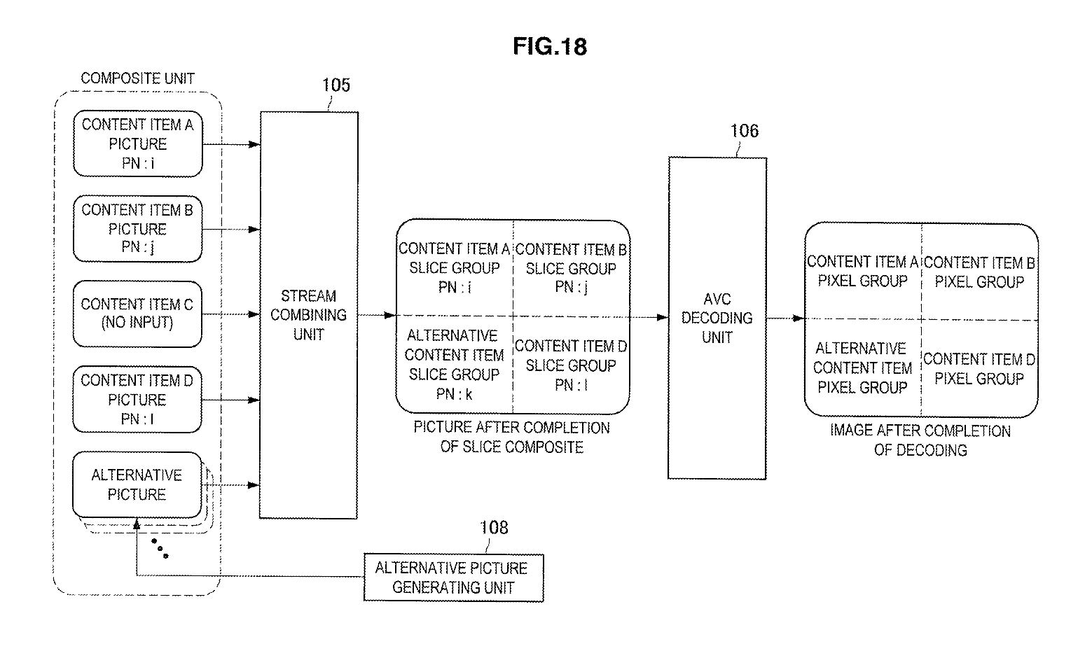

FIG. 18 shows a process of combining a plurality of encoded streams performed by the client terminal 100 according to an embodiment of the present disclosure. FIG. 18 shows the composite process in which, when encoded streams of the four moving image content items A to D are to be combined, encoded streams of the moving image content item C are not input at a composite timing.

When encoded streams of the moving image content item C are not input, the client terminal 100 sets the picture number PN of the alternative picture generated by the alternative picture generating unit 108 as k and incorporates the alternative picture into a place where the encoded streams of the moving image content item C are supposed to be combined. Then, the client terminal 100 combines slice groups of encoded streams of the four moving image content items in which the alternative picture is incorporated in the stream combining unit 105. One picture combined in the stream combining unit 105 is decoded in the AVC decoding unit 106 and serves as pixel groups of the moving image content items A, B, and D, and a pixel group of an alternative content item serving as an alternative to the moving image content item C.

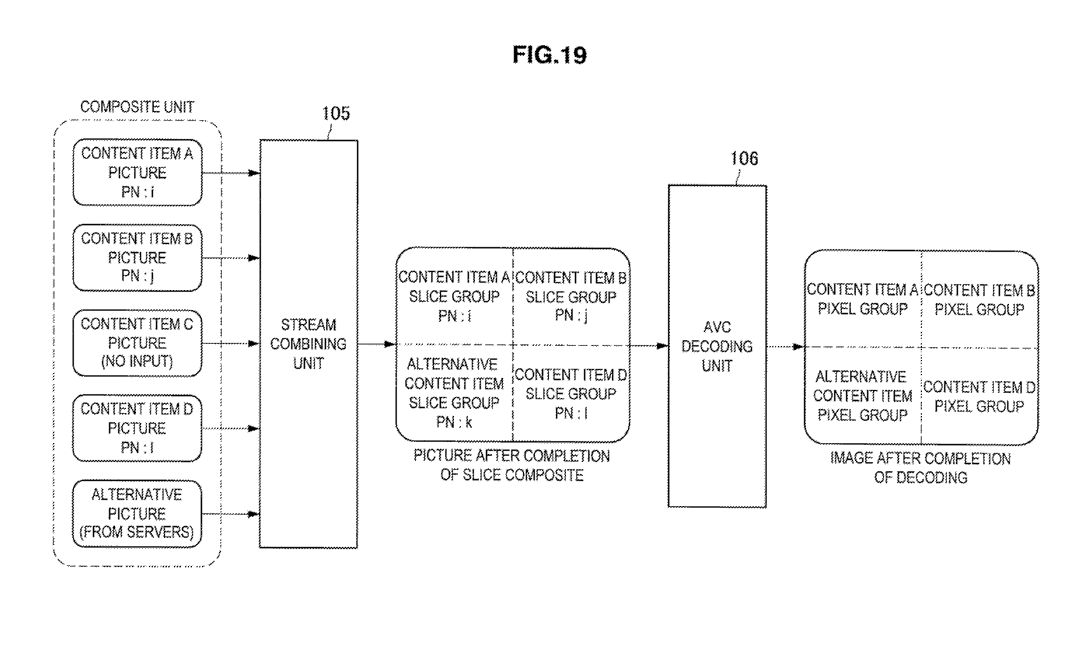

FIG. 19 shows a process of combining a plurality of encoded streams performed by the client terminal 100 according to an embodiment of the present disclosure. FIG. 19 shows the composite process in which, when encoded streams of the four moving image content items A to D are to be combined, the moving image content item C is not input at a composite timing, as in the example in FIG. 18.

FIG. 19 shows an example in which the alternative picture provided from the moving image content servers 2 and 3 is used as the alternative picture. When the moving image content item C is not input, the client terminal 100 sets the picture number PN of the alternative picture provided from the moving image content servers 2 and 3 as k and incorporates the alternative picture into a place where the moving image content item C is supposed to be combined.

Then, the client terminal 100 combines slice groups of encoded streams of the four moving image content items in which the alternative picture is incorporated in the stream combining unit 105. One picture combined in the stream combining unit 105 is decoded in the AVC decoding unit 106 and serves as pixel groups of the moving image content items A, B, and D, and a pixel group of an alternative content item serving as an alternative to the moving image content item C.

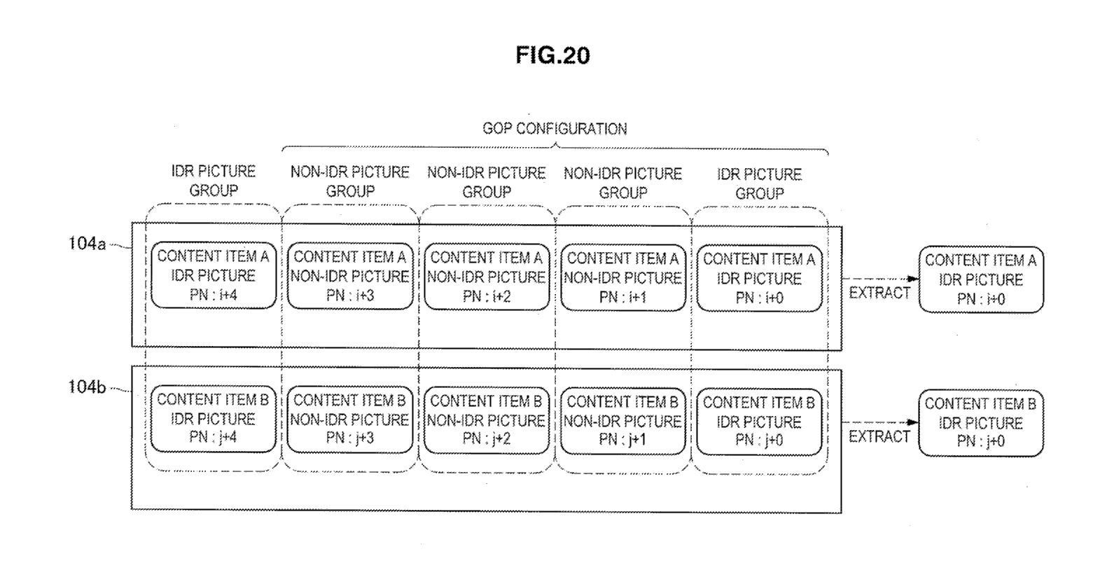

FIG. 20 shows an example of encoded streams that have arrived at the client terminal 100 according to an embodiment of the present disclosure. FIG. 20 shows the example of encoded streams at a time of normal reception when the encoded streams arrive at the client terminal 100 without a picture loss. Note that FIG. 20 shows only the content buffering units 104a and 104b for convenience of description.

As shown in FIG. 20, when encoded streams arrive at the client terminal 100 normally without a loss, the client terminal 100 extracts pictures one by one from the content buffering units 104a and 104b and combines IDR pictures with each other and also combines non-IDR pictures with each other, thereby performing simultaneous reproduction and display of a plurality of moving image content items.

When at least one of the plurality of received encoded streams is lost, as described above, the client terminal 100 prepares for the alternative picture and combines pictures using the alternative picture.

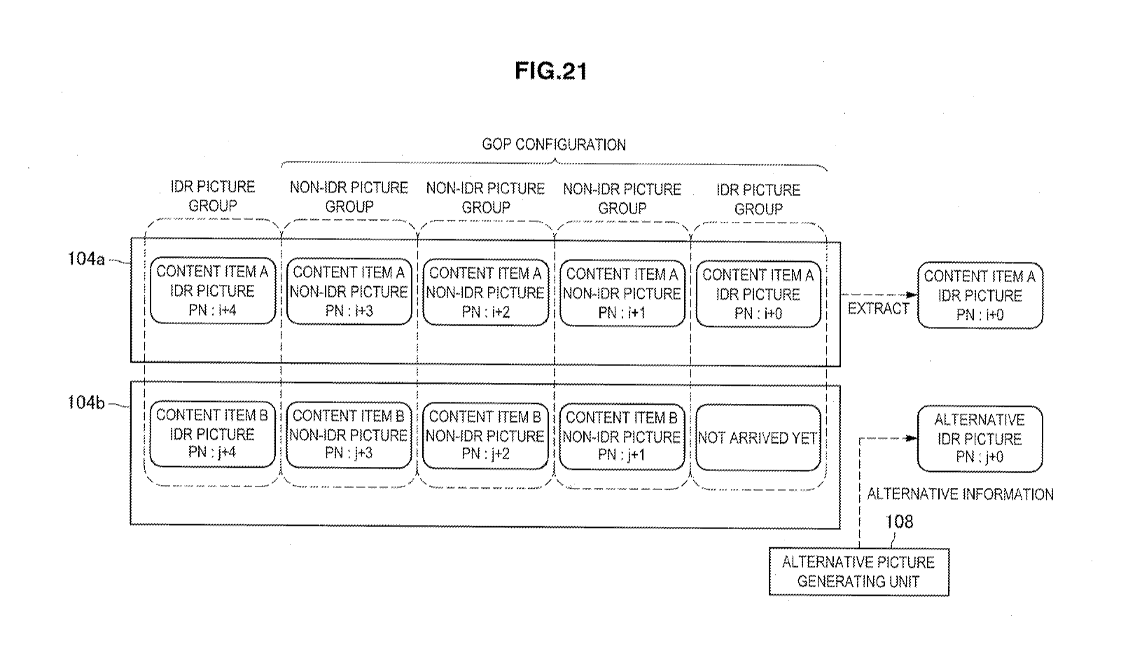

FIG. 21 shows an example of encoded streams that have arrived at the client terminal 100 according to an embodiment of the present disclosure. FIG. 21 shows the example of encoded streams when the IDR picture of the moving image content item B has not arrived at the client terminal 100 yet. Note that FIG. 21 shows only the content buffering units 104a and 104b for convenience of description. Further, the example shown in FIG. 21 corresponds to the processes in steps S125 to S129 in the flow chart shown in FIG. 15A.

As shown in FIG. 21, although there are IDR pictures of the moving image content item A, when an IDR picture of the moving image content item B, the IDR picture being supposed to be combined with the IDR picture of the moving image content item A, has not arrived at the client terminal 100, the client terminal 100 prepares for an alternative IDR picture from the alternative picture generating unit 108.

Even when a picture has not arrived yet, the client terminal 100 prepares for the alternative IDR picture from the alternative picture generating unit 108 and combines the alternative IDR picture with a picture in another encoded stream, thereby continuously performing simultaneous reproduction and display of a plurality of moving image content items.

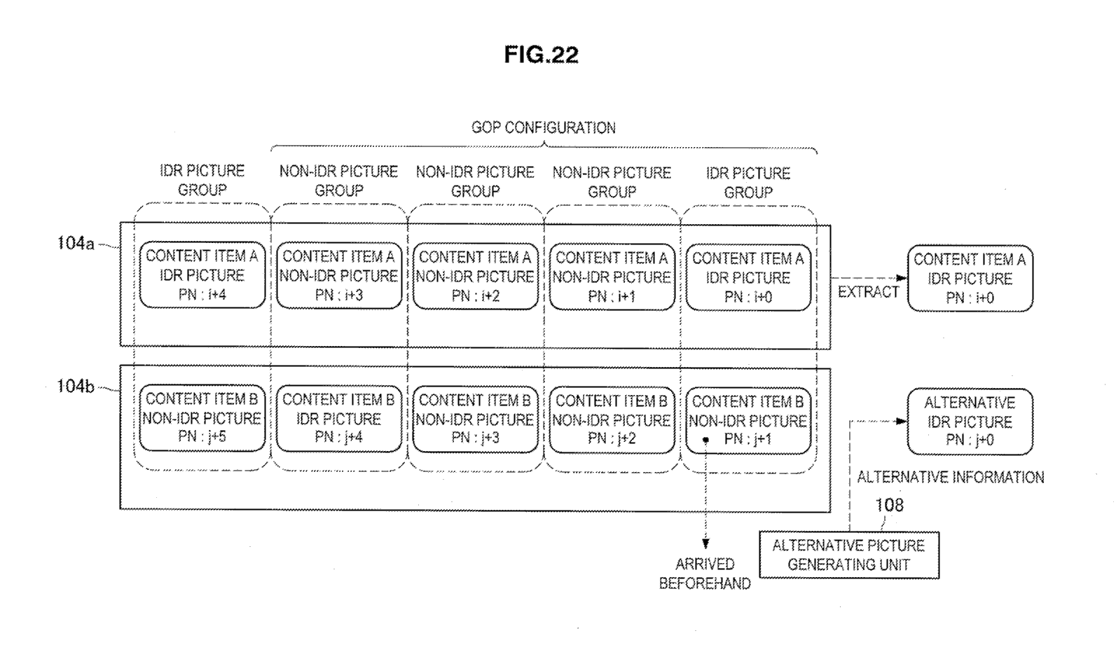

FIG. 22 shows an example of encoded streams that have arrived at the client terminal 100 according to an embodiment of the present disclosure. FIG. 22 shows a case where the arrival of a picture that is a composite target is delayed and a picture that is supposed to be combined at a subsequent composite timing or later arrives beforehand. Note that FIG. 22 shows only the content buffering units 104a and 104b for convenience of description. Further, the example shown in FIG. 22 corresponds to the processes in steps S125 to S129 in the flow chart shown in FIG. 15A.

When a protocol is used that generates a packet loss in a network, such as a user datagram protocol (UDP), in order to handle real-time content, as shown in FIG. 22, a picture that is supposed to be combined at a subsequent composite timing or later may arrive beforehand.

As shown in FIG. 22, when the arrival of the composite target picture is delayed and the picture that is supposed to be combined at a subsequent timing or later arrives at the client terminal 100 beforehand, the client terminal 100 prepares for an alternative IDR picture (an alternative IDR picture in the example shown in FIG. 22) from the alternative picture generating unit 108.

Even when the arrival of the composite target picture is delayed, the client terminal 100 prepares for the alternative picture from the alternative picture generating unit 108 and combines the alternative picture with a picture in another encoded stream, thereby continuously performing simultaneous reproduction and display of a plurality of moving image content items.

After executing the process of generating the alternative picture in this manner, as described above, the client terminal 100 removes a P picture, even when the P picture is normally received, after the IDR picture in the GOP, and replaces the P picture by a P picture using a skipped macro block. This is because the P picture is dependent on information of the precedent IDR picture.

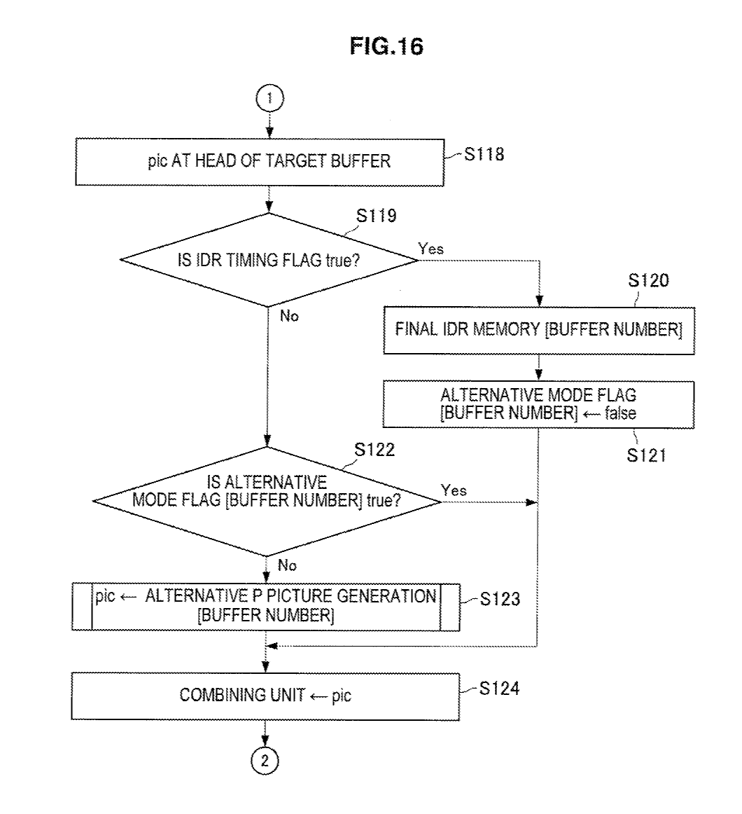

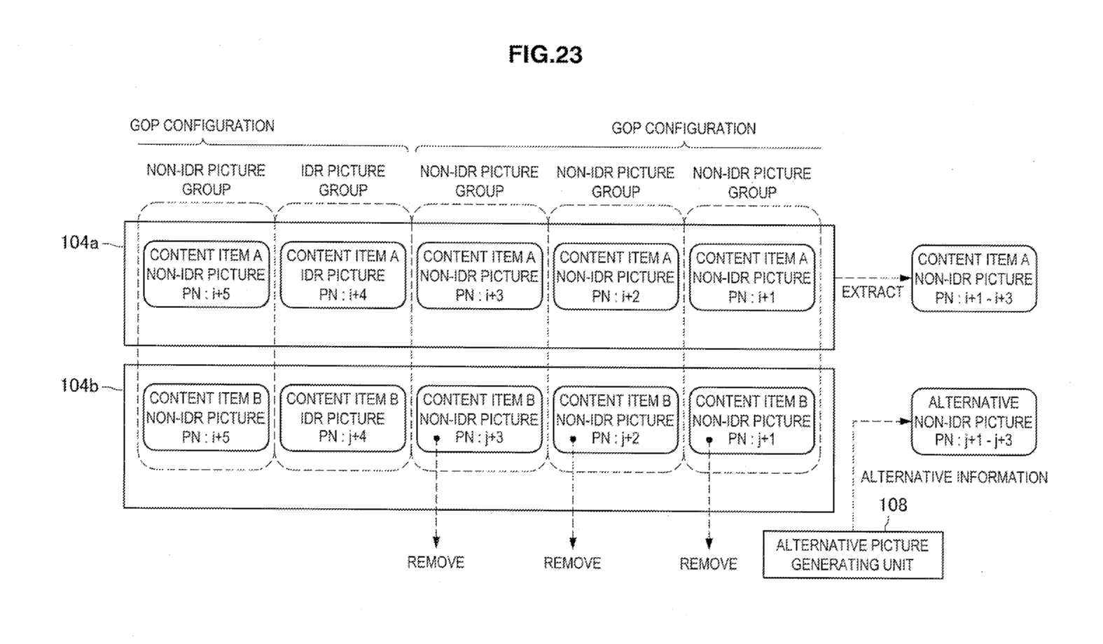

FIG. 23 shows an example of encoded streams that arrive at the client terminal 100 according to an embodiment of the present disclosure. FIG. 23 shows the example when an alternative picture is prepared because the arrival of a picture that is a composite target is delayed and a picture that is supposed to be combined at a subsequent composite timing or later has arrived beforehand, as in FIG. 22. The example shown in FIG. 23 corresponds to the processes in steps S122 to S124 in the flow chart shown in FIG. 16.

As shown in FIG. 23, the client terminal 100 removes P pictures after an IDR picture in a GOP and replaces the P pictures by P pictures that are prepared by the alternative picture generating unit 108 using a skipped macro block, thereby combining a natural image with another moving image content item.

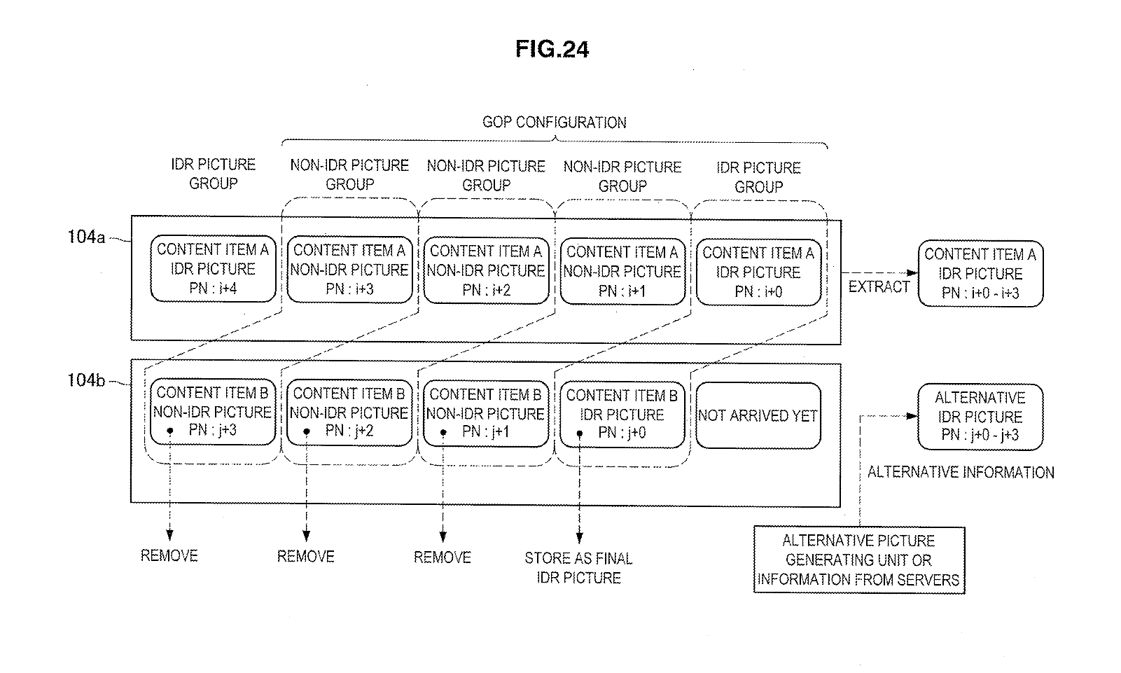

FIG. 24 shows an example of encoded streams that arrive at the client terminal 100 according to an embodiment of the present disclosure. FIG. 24 shows the example when the arrival of encoded streams of the moving image content item B at the client terminal 100 is delayed. Note that FIG. 24 shows only the content buffering units 104a and 104b for convenience of description. Further, the example shown in FIG. 24 corresponds to the processes in steps S114 to S117 in the flow chart shown in FIG. 15C.

As shown in FIG. 24, when the arrival of encoded streams of the moving image content item B at the client terminal 100 is delayed, the client terminal 100 prepares for an alternative picture with respect to the moving image content item B from the alternative picture generating unit 108 and combines the alternative picture with a picture of the moving image content item A. Even when the arrival of encoded streams of the moving image content item B is delayed, the client terminal 100 prepares for the alternative picture from the alternative picture generating unit 108 and combines the alternative picture with the picture in another encoded stream, thereby continuously performing simultaneous reproduction and display of a plurality of moving image content items.

Here, when the moving image content item B is distributed in real time and an alternative picture to the picture that arrives late has been prepared, as shown in FIG. 24, the client terminal 100 removes the picture that arrives late in order to maintain the time axis. However, as described above, since it is more natural to replace, by a latest IDR picture, a subsequent IDR picture that is lost, the client terminal 100 holds the IDR picture in any of the final IDR picture memory units 123a to 123n.

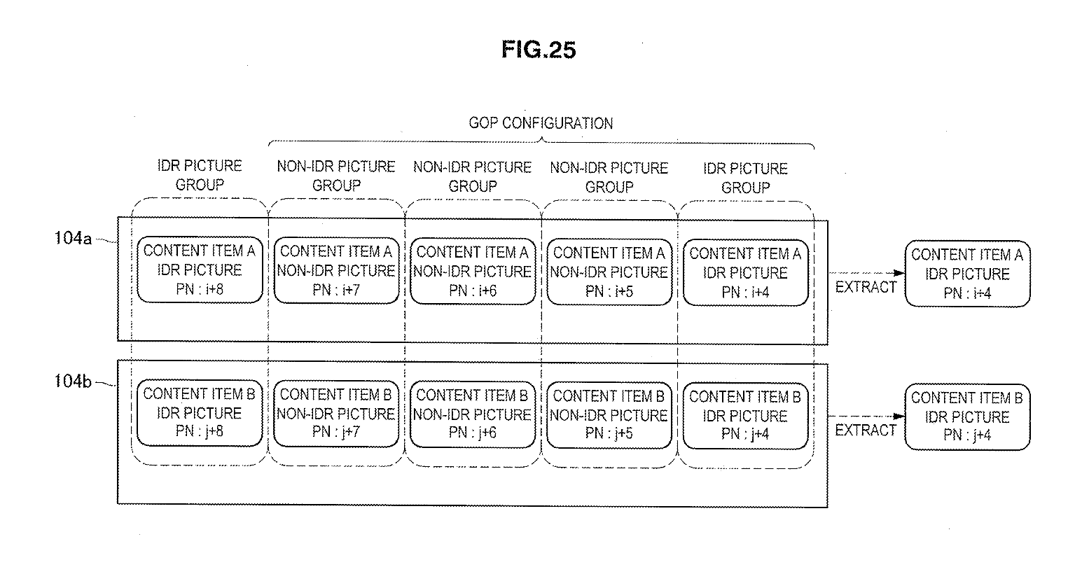

After that, when the delay is solved and IDR pictures are able to be combined with each other and non-IDR pictures are able to be combined each other with respect to the moving image content items A and B, the client terminal 100 restarts a composite process using the respective pictures in encoded streams of the moving image content items A and B. FIG. 25 shows an example of encoded streams that arrive at the client terminal 100 according to an embodiment of the present disclosure, and is an example when the composite process is restarted using the respective pictures in encoded streams of the moving image content items A and B. When the delay is solved in this manner, the client terminal 100 restarts the composite process using the respective pictures in encoded streams of the moving image content items A and B.

When the distributed moving image content is not distributed in real time but is accumulated in the moving image content servers 2 and 3 in advance, the client terminal 100 does not remove pictures unlike in a case where the moving image content is distributed in real time. This is because it is more natural to maintain the continuity of content than to maintain the time axis; however, the present disclosure is not limited to this example. Even when the distributed moving image content is accumulated in the moving image content servers 2 and 3 in advance, the client terminal 100 may remove pictures as in a case where the moving image content is distributed in real time.

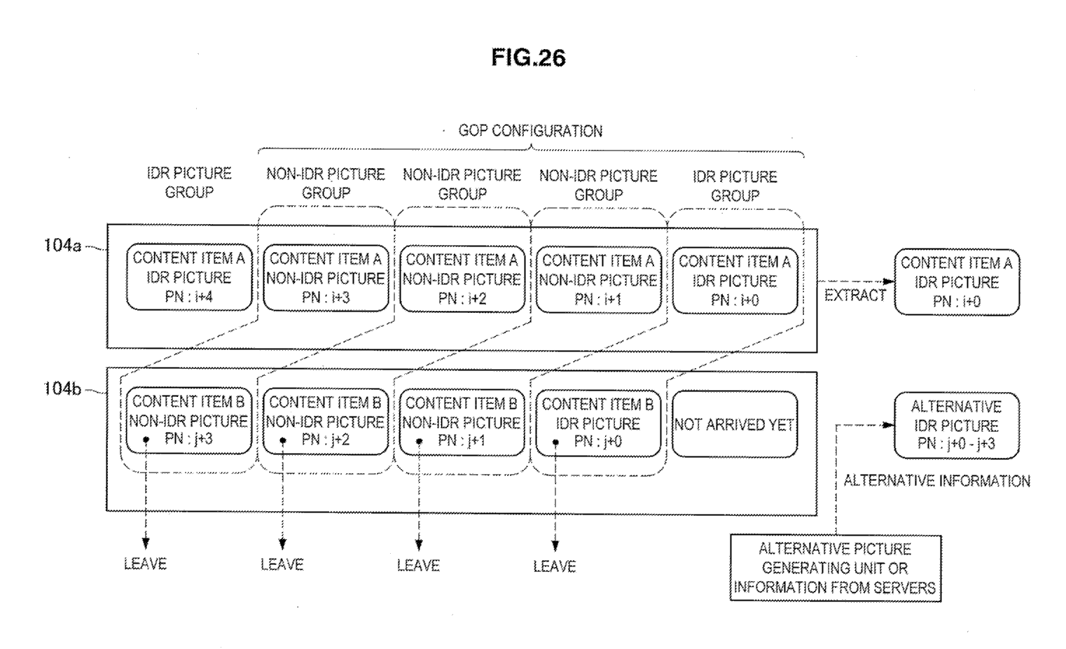

FIG. 26 is an example of encoded streams that arrive at the client terminal 100 according to an embodiment of the present disclosure. FIG. 26 shows the example when the arrival of encoded streams of the moving image content item B at the client terminal 100 is delayed as in the example shown in FIG. 24. Note that FIG. 26 shows only the content buffering units 104a and 104b for convenience of description. Further, the example shown in FIG. 26 corresponds to the processes in steps S118 to S124 in the flow chart shown in FIG. 16.

Even when the distributed moving image content item B is accumulated in the moving image content servers 2 and 3 in advance, when the arrival of encoded streams of the moving image content item B at the client terminal 100 is delayed, the client terminal 100 prepares for an alternative picture with respect to the moving image content item B from the alternative picture generating unit 108 and combines the alternative picture with a picture of the moving image content item A.

Further, in the example shown in FIG. 26, even when the alternative picture has been prepared for the picture that arrives late, the client terminal 100 leaves, not remove, the picture that arrives late.

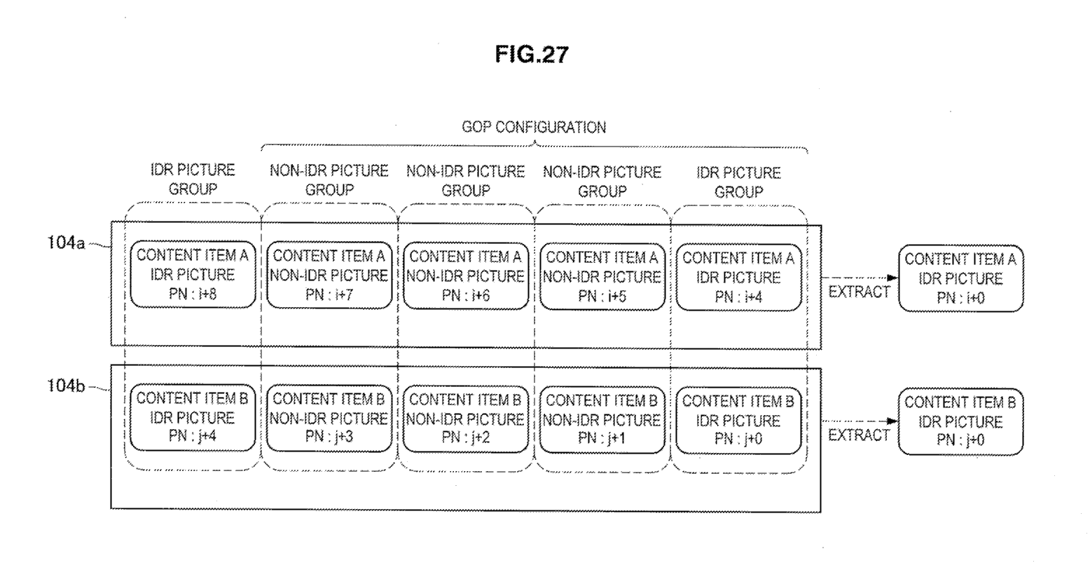

After that, when the delay is solved and IDR pictures are able to be combined with each other and non-IDR pictures are able to be combined with each other with respect to the moving image content items A and B, the client terminal 100 restarts a composite process using the respective pictures in encoded streams of the moving image content items A and B. FIG. 27 shows an example of encoded streams that arrive at the client terminal 100 according to an embodiment of the present disclosure.

In this manner, the client terminal 100 according to an embodiment of the present disclosure can change the generation of an alternative picture or the management of an arrived picture in accordance with whether or not a composite target picture is an IDR picture or whether or not moving image content that is a composite target is distributed in real time.

### 2. CONCLUSION

As described above, according to an embodiment of the present disclosure, there is provided the client terminal 100 that receives and combines encoded streams of a plurality of moving image content items and simultaneously reproduces the plurality of moving image content items. The client terminal 100 according to an embodiment of the present disclosure prepares for an alternative picture when a picture in one of encoded streams is lost or when the arrival of a picture is delayed in a case of receiving and combining encoded steams of the plurality of moving image content items.

By preparing for the alternative picture when a loss or a delay is generated, the client terminal 100 according to an embodiment of the present disclosure can avoid a situation in which composite of the plurality of encoded streams is failed because of the loss or the delay in one of the encoded streams.

The client terminal 100 according to an embodiment of the present disclosure can use, as the alternative picture, an entirely black screen, a final IDR picture that is received normally from a network, an image describing an error state, and the like. By preparing for such an alternative picture, the client terminal 100 can provide the most suitable viewing environment for users.

The client terminal 100 according to an embodiment of the present disclosure can switch processes of the alternative picture in accordance with a property of distributed content. By switching processes of the alternative picture in accordance with a property of distributed content, the client terminal 100 according to an embodiment of the present disclosure can minimize a delay of information when a real-time property of content is important and can minimize a loss of information when the continuity of content is important.

Steps in processes executed by devices in this specification are not necessarily executed chronologically in the order described in a sequence chart or a flow chart. For example, steps in processes executed by devices may be executed in a different order from the order described in a flow chart or may be executed in parallel.

Further, a computer program can be created which causes hardware such as a CPU, ROM, or RAM, incorporated in each of the devices, to function in a manner similar to that of structures in the above-described devices. Furthermore, it is possible to provide a recording medium having the computer program recorded thereon. Moreover, by configuring respective functional blocks shown in a functional block diagram as hardware, the hardware can achieve a series of processes.

Although preferred embodiments of the present disclosure are described in detail with reference to the accompanying drawings, the technical scope of the present disclosure is not limited thereto. It should be understood by those skilled in the art that various modifications, combinations, sub-combinations and alterations may occur depending on design requirements and other factors insofar as they are within the scope of the appended claims or the equivalents thereof.

Additionally, the present technology may also be configured as below.

(1) An image processing device including:

a combining unit configured to combine a plurality of encoded streams before the streams are decoded and to detect a loss of information in the plurality of encoded streams; and

an alternative information providing unit configured to provide the combining unit with alternative information that serves as an alternative to the loss when the combining unit detects the loss,

wherein the combining unit performs composite by replacing a portion including the loss in information in the plurality of encoded streams by the alternative information.

(2) The image processing device according to (1), wherein the alternative information providing unit includes

an alternative information generating unit configured to generate the alternative information.

(3) The image processing device according to (2), wherein the alternative information generating unit generates the alternative information using the plurality of encoded streams.

(4) The image processing device according to (2), wherein the alternative information generating unit generates the alternative information using an encoded stream that is different from an encoded stream that is to be combined by the combining unit.

(5) The image processing device according to any one of (2) to (4), wherein the alternative information generating unit generates the alternative information using the plurality of encoded streams, with respect to a picture that is able to be encoded alone.

(6) The image processing device according to any one of (1) to (5), wherein the alternative information providing unit acquires the alternative information from a device that distributes the encoded streams.

(7) The image processing device according to any one of (2) to (6), wherein the combining unit changes how to handle information in a stream on and after generation of the loss, in accordance with a kind of the encoded streams.

(8) The image processing device according to (7), wherein the combining unit removes information corresponding to the loss that is detected by the combining unit when arrival of the information is delayed.

(9) The image processing device according to (7), wherein the alternative information generating unit generates the alternative information using information corresponding to the loss that is detected by the combining unit when arrival of the information is delayed.

(10) The image processing device according to any one of (2) to (9), wherein the alternative information generating unit uses a skipped macro block as the alternative information for a picture that is unable to be encoded alone.

(11) An information processing method including:

combining a plurality of encoded streams before the streams are decoded;

detecting a loss of information in the plurality of encoded streams; and

providing alternative information serving as an alternative to the loss when the loss is detected in the detecting step,

wherein in the combining step, composite is performed by replacing a portion including the loss in information in the plurality of encoded streams by the alternative information.

(12) A computer program causing a computer to execute:

combining a plurality of encoded streams before the streams are decoded;

detecting a loss of information in the plurality of encoded streams; and

providing alternative information serving as an alternative to the loss when the loss is detected in the detecting step,

wherein in the combining step, composite is performed by replacing a portion including the loss in information in the plurality of encoded streams by the alternative information.

What is claimed is:

1. An image processing device comprising:
a combining unit configured to combine a plurality of encoded streams before the streams are decoded and to detect a loss of information in the plurality of encoded streams; and
an alternative information providing unit configured to provide the combining unit with alternative information that serves as an alternative to the loss when the combining unit detects the loss,
wherein the combining unit performs composite by replacing a portion including the loss in information in the plurality of encoded streams by the alternative information.

2. The image processing device according to claim 1, wherein the alternative information providing unit includes an alternative information generating unit configured to generate the alternative information.

3. The image processing device according to claim 2, wherein the alternative information generating unit generates the alternative information using the plurality of encoded streams.

4. The image processing device according to claim 2, wherein the alternative information generating unit generates the alternative information using an encoded stream that is different from an encoded stream that is to be combined by the combining unit.

5. The image processing device according to claim 2, wherein the alternative information generating unit generates the alternative information using the plurality of encoded streams, with respect to a picture that is able to be encoded alone.

6. The image processing device according to claim 1, wherein the alternative information providing unit acquires the alternative information from a device that distributes the encoded streams.

7. The image processing device according to claim 2, wherein the combining unit changes how to handle information in a stream on and after generation of the loss, in accordance with a kind of the encoded streams.

8. The image processing device according to claim 7, wherein the combining unit removes information corresponding to the loss that is detected by the combining unit when arrival of the information is delayed.

9. The image processing device according to claim 7, wherein the alternative information generating unit generates the alternative information using information corresponding to the loss that is detected by the combining unit when arrival of the information is delayed.

10. The image processing device according to claim 2, wherein the alternative information generating unit uses a skipped macro block as the alternative information for a picture that is unable to be encoded alone.

11. An information processing method comprising:
combining a plurality of encoded streams before the streams are decoded;
detecting a loss of information in the plurality of encoded streams; and
providing alternative information serving as an alternative to the loss when the loss is detected in the detecting step,
wherein in the combining step, composite is performed by replacing a portion including the loss in information in the plurality of encoded streams by the alternative information.

12. A computer program causing a computer to execute:
combining a plurality of encoded streams before the streams are decoded;
detecting a loss of information in the plurality of encoded streams; and
providing alternative information serving as an alternative to the loss when the loss is detected in the detecting step,
wherein in the combining step, composite is performed by replacing a portion including the loss in information in the plurality of encoded streams by the alternative information.
